(19) United States
(12) Patent Application Publication
(10) Pub. No.: US 2025/0131321 A1
(43) Pub. Date: Apr. 24, 2025

(54) Efficient Training Mixture Calibration for Training Machine-Learned Models

(71) Applicant: Google LLC, Mountain View, CA (US)

(72) Inventors: Wei Yu, Palo Alto, CA (US); Sang Xie, Mountain View, CA (US); Hieu Hy Pham, Mountain View, CA (US); Quoc V. Le, Sunnyvale, CA (US)

(21) Appl. No.: 18/489,503

(22) Filed: Oct. 18, 2023

(51) Int. Cl. G06N 20/00

(52) U.S. Cl. CPC G06N 20/00

(57) ABSTRACT

Systems and methods are provided for efficiently calibrating a data mixture for training machine-learned models (e.g., machine-learned sequence processing models, such as transformer-based models). For example, machine-learned models can be trained over a broad dataset that can include multiple different categories of data. The mixture of data categories within the dataset can influence model performance. To improve the performance of machine-learned models, example implementations of the present disclosure can learn a distribution of data categories using a lightweight proxy model before initiating training of a large primary model. In this manner, for instance, example implementations can obtain an improved training data distribution with less computational expense and can leverage the learned training data distribution to better train a large primary model.

### FIELD

The present disclosure relates generally to machine learning. More particularly, the present disclosure relates to calibrating a mixture of training data for training a machine-learned model.

### BACKGROUND

A computer can receive input(s). The computer can execute instructions to process the input(s) to generate output(s) using a parameterized model. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model.

### SUMMARY

Aspects and advantages of embodiments of the present disclosure will be set forth in part in the following description, or can be learned from the description, or can be learned through practice of the embodiments.

Example aspects of the present disclosure provide an example computer-implemented method for calibrating a training distribution for training a machine-learned model. In some implementations, the example method can include a training dataset characterized by a plurality of data domains. The method can further comprise training a reference model using a first batch of training examples, the first batch of training examples sampled from the training dataset according to an initial probability distribution over the plurality of data domains. The method can comprise training a proxy model using a second batch of training examples, the second batch of training examples sampled from the training dataset according to a proxy probability distribution over the plurality of data domains. The proxy model can be trained by evaluating, for a respective training iteration, a comparison between the reference model and the proxy model, wherein the comparison is evaluated using a plurality of learned distribution parameters. The method can comprise learning, jointly during training of the proxy model, the plurality of learned distribution parameters. The method can comprise outputting a calibrated training distribution over the plurality of data domains based on the plurality of learned distribution parameters.

In some implementations, the example method can comprise jointly learning the plurality of learned distribution parameters using distributionally robust optimization (DRO) over the plurality of data domains.

In some implementations of the example method, the plurality of learned distribution parameters can be used for weighting the comparison between the reference model and the proxy model.

In some implementations of the example method, the plurality of learned distribution parameters can be learned based on the comparison between the reference model and the proxy model.

In some implementations of the example method, the proxy model can be updated to change the comparison in a first direction; and the plurality of learned distribution parameters can be updated to change the comparison in a second, different direction.

In some implementations of the example method, jointly learning the learned distribution parameters can comprise updating the plurality of learned distribution parameters to amplify a difference metric computed between the reference model and the proxy model. In some implementations, training the proxy model can comprise updating the proxy model to decrease the difference metric computed between the reference model and the proxy model.

In some implementations of the example method, the method can comprise evaluating the comparison. Evaluating the comparison can comprise determining a plurality of difference metrics respectively for the plurality of data domains. The respective difference metric for a respective domain can comprise a comparison between: values generated by the reference model for training inputs from the respective domain, and values generated by the proxy model for the training inputs from the respective domain. Evaluating the comparison can further comprise weighting the plurality of difference metrics respectively using the plurality of learned distribution parameters and aggregating the weighted plurality of difference metrics.

In some implementations of the example method, the respective difference metric can comprise an excess loss of the proxy model as compared to the reference model.

In some implementations of the example method, the values generated by the proxy model for the training inputs from the respective domain can correspond to predictions associated with designated outputs.

In some implementations of the example method, a designated output can correspond to a ground truth token.

In some implementations of the example method, the method can comprise generating a training trajectory that accumulates a plurality of states for the plurality of learned distribution parameters; and determining the calibrated training distribution based on the plurality of states.

In some implementations of the example method, determining the calibrated training distribution based on the plurality of states can comprise one or more of: determining an average of the plurality of states; determining a weighted average of the plurality of states; or determining a representative value of a cluster of the plurality of states.

Example aspects of the present disclosure provide an example computer-implemented method for training a machine-learned model using a calibrated training mixture. The example method can comprise sampling a training example from a training dataset according to a calibrated training distribution. The example method can comprise training the machine-learned model using the training example. The calibrated training distribution can be a calibrated training distribution that was calibrated by accessing a training dataset characterized by a plurality of data domains; training a reference model using a first batch of training examples, the first batch of training examples sampled from the training dataset according to an initial probability distribution over the plurality of data domains; training a proxy model using a second batch of training examples, the second batch of training examples sampled from the training dataset according to a proxy probability distribution over the plurality of data domains, wherein the proxy model is trained by evaluating, for a respective training iteration, a comparison between the reference model and the proxy model, wherein the comparison is evaluated using a plurality of learned distribution parameters; learning, jointly during training of the proxy model, the plurality of learned distribution parameters; and determining the calibrated training distribution based on the plurality of learned distribution parameters.

In some implementations of the example method, training the machine-learned model can be computationally more expensive than training the proxy model.

In some implementations of the example method, the machine-learned model can be characterized by a first number of parameters; the proxy model can be characterized by a second number of parameters; and the first number of parameters can be at least ten times the second number of parameters.

In some implementations of the example method, the first number of parameters can be at least thirty times the second number of parameters.

In some implementations of the example method, the machine-learned model can be trained using a first training task; and the proxy machine-learned model can be trained using a second training task different from the first training task.

In some implementations of the example method, a training iteration of the machine-learned model can comprise executing a first number of floating point operations; and a training iteration of the proxy machine-learned model can comprise executing a second number of floating point operations that is fewer than the first number of floating point operations.

Example aspects of the present disclosure provide an example computing system. The computing system can comprise one or more processors and one or more non-transitory computer-readable media. The computer-readable media can store a machine-learned model and instructions. The machine-learned model can be a machine-learned model that was trained using a calibrated training distribution, wherein the calibrated training distribution was calibrated by: accessing a training dataset characterized by a plurality of data domains; training a reference model using a first batch of training examples, the first batch of training examples sampled from the training dataset according to an initial probability distribution over the plurality of data domains; training a proxy model using a second batch of training examples, the second batch of training examples sampled from the training dataset according to a proxy probability distribution over the plurality of data domains, wherein: the proxy model is trained by evaluating, for a respective training iteration, a comparison between the reference model and the proxy model, wherein the comparison is evaluated using a plurality of learned distribution parameters; learning, jointly during training of the proxy model, the plurality of learned distribution parameters; and determining the calibrated training distribution based on the plurality of learned distribution parameters. The instructions can be executable by the one or more processors to cause the computing system to perform one or more operations, the operations comprising: obtaining input data; and generating output data using the machine-learned model and based on the input data.

In some implementations of the example computing system, the calibrated training distribution was trained by jointly learning the plurality of learned distribution parameters using distributionally robust optimization (DRO) over the plurality of data domains.

Example aspects of the present disclosure provide one or more example non-transitory computer-readable media storing instructions that are executable by one or more processors to cause a computing system to perform operations, the operations comprising the example method.

Example aspects of the present disclosure provide an example computing system that includes one or more processors and the one or more example non-transitory computer-readable media.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example training sequence according to the present disclosure.

FIG. 2 depicts a block diagram, with additional detail, of one example implementation of the example training sequence of FIG. 1.

FIG. 3 depicts a block diagram, with additional detail, of one example implementation of the example training sequence of FIGS. 1 and 2.

FIG. 4 depicts a flow chart diagram of an example method for learning a calibrated training distribution, in which a proxy model and a plurality of learned distribution parameters can be trained based on a reference model.

FIG. 5 depicts a flow chart diagram of an example method for training a machine-learned model based on a calibrated training distribution, in which training examples can be sampled from a training dataset based on the calibrated training distribution.

FIG. 6 depicts a flow chart diagram of an example method for using a machine-learned model, which was trained based on a calibrated training distribution, to generate an output.

FIG. 7 is a flow chart diagram illustrating an example method for training a machine-learned model according to example implementations of aspects of the present disclosure;

FIG. 8 is a block diagram of an example processing flow for using machine-learned model(s) to process input(s) to generate output(s) according to example implementations of aspects of the present disclosure;

FIG. 9 is a block diagram of an example sequence processing model according to example implementations of aspects of the present disclosure;

FIG. 10 is a block diagram of an example technique for populating an example input sequence for processing by a sequence processing model according to example implementations of aspects of the present disclosure;

FIG. 11 is a block diagram of an example model development platform according to example implementations of aspects of the present disclosure;

FIG. 12 is a block diagram of an example training workflow for training a machine-learned model according to example implementations of aspects of the present disclosure;

FIG. 13 is a block diagram of an inference system for operating one or more machine-learned model(s) to perform inference according to example implementations of aspects of the present disclosure;

FIG. 14 is a block diagram of an example networked computing system according to example implementations of aspects of the present disclosure;

FIG. 15 is a block diagram of an example computing device according to example implementations of aspects of the present disclosure; and

FIG. 16 is a block diagram of an example computing device according to example implementations of aspects of the present disclosure. Reference numerals that are repeated across plural figures are intended to identify various implementations of the same elements.

### DETAILED DESCRIPTION

### Overview

Generally, the present disclosure is directed to systems and methods for efficiently calibrating a data mixture for training machine-learned models (e.g., machine-learned sequence processing models, such as transformer-based models). For example, machine-learned models can be trained over a broad dataset that can include multiple different categories of data. The mixture of data categories within the dataset can influence model performance. To improve the performance of machine-learned models, example implementations of the present disclosure can learn a distribution of data categories using a lightweight proxy model before initiating training of a large primary model. In this manner, for instance, example implementations can obtain an improved training data distribution with less computational expense and can leverage the learned training data distribution to better train a large primary model.

For example, a proxy model can be trained using training samples that are obtained according to a training data mixture having an initial proxy distribution. The proxy model can be trained using a model training objective that is based on a comparison between the proxy model and a reference model that is calibrated according to a plurality of learned distribution parameters. The reference model can provide a baseline performance. The comparison can be an excess loss of the proxy model as compared to the reference model.

The plurality of learned distribution parameters can calibrate the comparison by weighting respective comparison values. For instance, each data domain can be associated with a learned parameter. The comparison can include an aggregation of domain-specific comparison components. The plurality of learned distribution parameters can thereby amplify or diminish the relative contribution of the comparison over a particular data domain to the aggregate comparison. In this manner, for instance, the plurality of learned distribution parameters can shape the aggregate comparison and thus the evaluation of the model training objective.

For example, the model training objective can include an optimization of a performance of the proxy model. For instance, the model training objective can include a minimization of an excess loss of the proxy model over the reference model. The plurality of learned distribution parameters can amplify the excess loss over particular data domains to induce updates to the proxy model that improve performance in those particular data domains.

This selective amplification can be learned. For instance, the plurality of learned distribution parameters can be updated based on a distribution parameter objective. The distribution parameter objective can be configured to learn distribution parameters such that data domains associated with lower proxy model performance are weighted more highly in the model training objective. By weighting the loss more highly for data domains with lower performance, the proxy model can be trained with greater emphasis on improving performance in those data domains by increasing a contribution of training examples from those data domains to the model training objective.

The learned distribution parameters can inform the selection of a final training mixture for training a primary machine-learned model. For example, values of the learned distribution parameters can correspond to proportions in which the respective data domains should be represented in the training mixture. For instance, a larger value might have been learned because a corresponding data domain was challenging for the proxy model or was otherwise associated with lower performance of the proxy model with respect to the reference model. In the same manner, the larger value can be used to designate a larger proportion of training data for training the primary machine-learned model in that challenging data domain. Similarly, a smaller value might have been learned because a corresponding data domain was not challenging for the proxy model or was otherwise associated with higher performance of the proxy model with respect to the reference model. As such, the smaller value can be used to designate a smaller proportion of the training data for training the primary machine-learned model in that relatively easy data domain, as less training repetitions may be needed to achieve satisfactory performance in that data domain.

In some instances, the primary model can be a general-purpose pretrained model capable of being used in a variety of downstream tasks. In some instances, the subject matter of this disclosure can be used to select an efficient general-purpose training mixture without knowledge of any downstream task or set of downstream tasks.

Technical effects and benefits of the present disclosure can include improved accuracy or quality of the primary model; reduced energy consumption; reduced training costs and training time; optimizing without the use of downstream task data; and improved versatility of a trained primary model.

Example implementations of the present disclosure can improve the accuracy and output quality of a primary model by selecting a better optimized training mixture compared to previous methods. In some example tests, optimizing domain weights according to the present disclosure improved average one-shot downstream accuracy of a primary model by 6.5 percent compared to other choices of training mixture.

Example implementations of the present disclosure can also improve the versatility of a primary model. In some instances, example implementations of the present disclosure can improve the accuracy of a primary model on all domains in the training mixture, including domains whose mixture proportion is reduced. In some example tests according to the present disclosure, a primary model trained according to the present disclosure had a reduced log-perplexity score for every single data domain in the training data, as compared to a second primary model trained on other choices of training mixture.

Additionally, example implementations of the present disclosure can improve the versatility of an optimized primary model by optimizing the primary model without dependence on a particular set of downstream tasks. In some instances, an optimized primary model can be an optimized general-purpose pretrained model capable of performing a plurality of tasks. In some instances, a pretrained general-purpose model can later be fine-tuned using downstream task data. In other instances, a pretrained general-purpose model can perform a downstream task without the need for fine-tuning. This versatility can enable reduced energy usage and training costs, such as by enabling the use of one optimized primary model for multiple tasks.

In addition to improving versatility, example implementations of optimizing a training mixture without knowledge of or dependence on a set of downstream tasks has other benefits. These benefits can include reduced need for the costly collection, labeling, and other processing of downstream training data; reduced energy usage; and reduced training costs.

Example implementations of the present disclosure can be used to reduce training costs of a primary model by allowing the primary model to achieve a target performance in fewer training iterations. In some example tests, a first primary model was trained on domain weights optimized according to the present disclosure and achieved a threshold accuracy in 2.6 times fewer training iterations (about 75 thousand vs. about 200 thousand) than a second primary model trained on prior published choices of training mixture, where the threshold accuracy was equal to the second primary model's peak accuracy.

Example implementations of the present disclosure can also reduce training costs by enabling the optimization of training weights using a proxy and reference model that are much cheaper to train than a primary model. In some example tests according to the present disclosure, optimizing the domain weights was performed using only 8 percent of the compute required to train a large model once.

A technical effect of example implementations of the present disclosure is increased energy efficiency in performing operations using machine-learned models, thereby improving the functioning of computers implementing such models. For instance, example implementations can provide for more energy-efficient training operations or model updates by identifying an optimized training data mixture using lightweight reference/proxy models. In some scenarios, increased energy efficiency can provide for less energy to be used to perform a given number of update iterations (e.g., less energy expended to maintain the model in memory, less energy expended to perform calculations within the model, such as computing gradients, backpropagating a loss, etc.). In some scenarios, increased energy efficiency can provide for more update iterations to be completed for a given energy budget (e.g., a larger quantity of iterations, etc.). In some scenarios, greater expressivity afforded by model architectures and training techniques of the present disclosure can provide for a given level of functionality to be obtained in fewer training iterations, thereby expending a smaller energy budget. In some scenarios, greater expressivity afforded by model architectures and training techniques of the present disclosure can provide for an extended level of functionality to be obtained in a given number of training iterations, thereby more efficiently using a given energy budget.

In this manner, for instance, the improved energy efficiency of example implementations of the present disclosure can reduce an amount of pollution or other waste associated with implementing machine-learned models and systems, thereby advancing the field of machine-learning and artificial intelligence as a whole. The amount of pollution can be reduced in toto (e.g., an absolute magnitude thereof) or on a normalized basis (e.g., energy per task, per model size, etc.). For example, an amount of CO2 released (e.g., by a power source) in association with training and execution of machine-learned models can be reduced by implementing more energy-efficient training or inference operations. An amount of heat pollution in an environment (e.g., by the processors/storage locations) can be reduced by implementing more energy-efficient training or inference operations.

With reference now to the Figures, example embodiments of the present disclosure will be discussed in further detail.

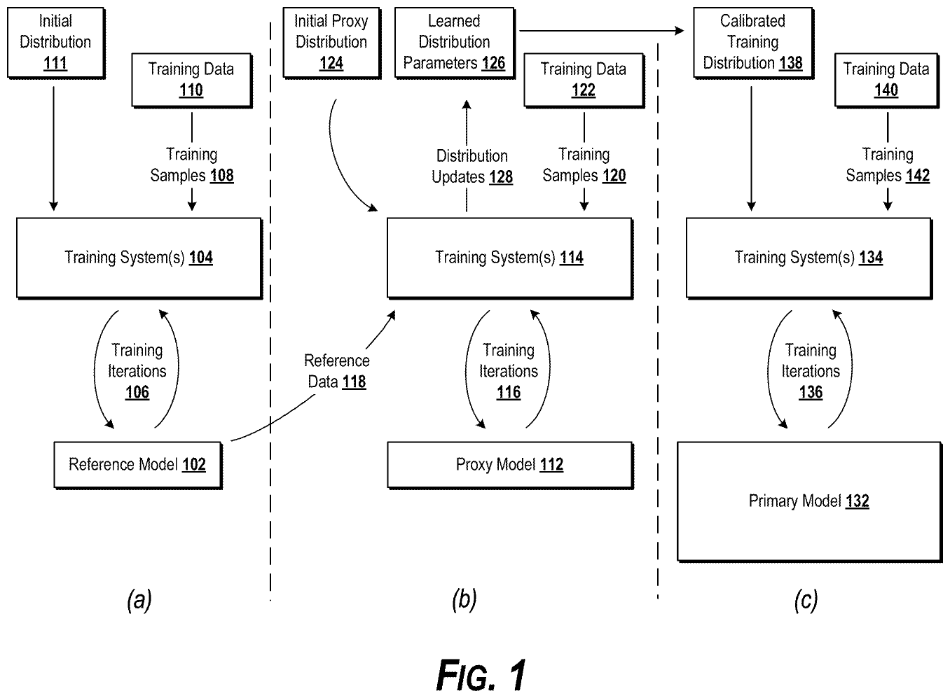

FIG. 1 illustrates a block diagram of an example training sequence according to the present disclosure. FIG. 1 is divided, using vertical dashed lines, into blocks (a), (b), and (c). Each block represents a subsequence of the example training sequence of FIG. 1. These subsequences can, in some example embodiments, be performed sequentially, with subsequence (a) being fully performed before subsequence (b) is begun, and subsequence (b) being fully performed before subsequence (c) is begun. However, a person skilled in the art will recognize that other sequencing arrangements are possible, and the present disclosure does not require any subsequence to be fully performed before any other subsequence can begin.

Block (a) of FIG. 1 depicts a portion of the example training sequence of FIG. 1 in which a reference model 102 is trained. Block (b) of FIG. 1 depicts a portion of the example training sequence of FIG. 1 in which a proxy model 112 and learned distribution parameters 126 are jointly trained using, in part, reference data 118 from the reference model 102. Block (c) of FIG. 1 depicts a portion of the example training sequence of FIG. 1 in which a primary model 132 is trained using, in part, a calibrated training distribution 138 based, at least in part, on one or more states of the learned distribution parameters 126 during or after subsequence (b).

Block (a) of FIG. 1 depicts a portion of the example training sequence of FIG. 1 in which a reference model 102 is trained. Block (a) of FIG. 1 contains a reference model 102, which can be trained by one or more training system(s) 104 over the course of one or more training iterations 106. In a respective training iteration 106, the training system(s) 104 can sample one or more training samples 108 from the training data 110 based on an initial distribution 111 and train the reference model 102 using the training samples 108.

Block (a) of FIG. 1 depicts a reference model 102. The reference model 102 can be, for example, a machine-learned model. In some instances, the reference model 102 can be, for example, a relatively small machine-learned model, such as a 280-million-parameter model, which can be trained using less time and/or computing power than a larger machine-learned model, such as an 8-billion-parameter model. However, in some example tests according to the present disclosure, the reference model 102 can be the same size as the primary model 132 depicted in block (c).

The reference model 102 can be or include various different types of machine-learned model architectures. The reference model 102 can be or include a sequence processing model that is configured to generate one or more output(s) in a sequence based on one or more input(s) in a sequence. In some instances, the reference model can be a language model, image processing model, audio processing model, etc. In some instances, the reference model 102 can leverage an attention mechanism such as self-attention. For example, the reference model 102 can be a multi-headed self-attention model (e.g. an encoder-only, encoder-decoder, or decoder-only transformer language model). In some instances, the reference model 102 can be specially configured for a specific application area. In other instances, the reference model 102 can have a more general-purpose configuration.

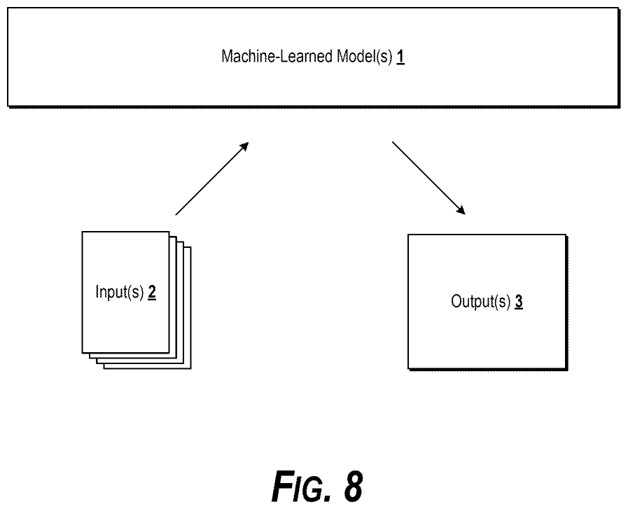

Block (a) of FIG. 1 also depicts one or more training system(s) 104. The training system(s) 104 can be, for example, one or more computing systems configured to train one or more machine-learned models. The training system(s) 104 can be located on a single computing system or distributed across multiple computing systems. In some instances, the training system(s) 104 can correspond to a training computing system 50, as depicted in FIG. 8a.

Block (a) of FIG. 1 also depicts training data 110, from which the training system(s) 104 can, for example, sample one or more training samples 108 to use in one or more training iterations 106. The training data 110 can include, for example, image data or text data.

The training data 110 can include data associated with a plurality of distinct data domains. A data domain can be a subset of the training dataset 110 having identifiable characteristics that distinguish it from another domain. A data domain can be defined by one or more sources from which data was extracted (e.g. legal cases from one or more court systems) or by other characteristics of the data, e.g. by a language associated with the data (e.g. French audio clips, Python code), a method by which the data was collected (e.g. by aggregating public domain web data, such as by referencing one or more popularity scores of one or more internet hyperlinks), or any other metric used to categorize data into distinct domains (e.g. data density, data quality, data format, etc.). A data domain can be derived from a single source or from multiple sources. In some embodiments, the training data 110 can include one or more public domain datasets containing a mixture of data domains identified by a publisher of the public domain dataset.

Examples of existing multi-domain data sets serve to further illustrate how a data domain can be defined. One such data set is known as The Pile, comprising text data associated with multiple domains, such as a “Books3” data domain characterized by data derived from books, a “YoutubeSubtitles” domain characterized by data derived from the subtitles of videos from the website YouTube, a “EuroParl” domain characterized by a multilingual parallel corpus developed for machine translation, a “PhilPapers” domain characterized by academic papers whose topic is philosophy, an “OpenWebText2” domain characterized by data scraped from a variety of websites based on highly upvoted links from the website Reddit, a “USPTO Backgrounds” domain, and other text domains. Another example multi-domain data set is known as the Multi-Domain Sentiment Dataset v2.0, a data set containing product reviews from Amazon.com, with domains defined by the type of product being reviewed (e.g. books, musical instruments).

Block (a) of FIG. 1 also depicts an initial distribution 111. The training system(s) 104 can select training samples 108 according to the initial distribution 111, such that the distribution of selected training samples 108 approximates the initial distribution 111 within an acceptable margin. In some instances, each datapoint within the training data 110 can belong to one or more of a finite number of data domains, and the initial distribution 111 can be a discrete set of probabilities or percentages, with each data domain having an associated probability or percentage. In this manner, for instance, the training system(s) 104 can sample the training samples 108 from the training data 110 according to a probability from the initial distribution 111 that is associated with a domain from which the training samples 108 are drawn. In other instances, the initial distribution 111 can be more complex. For example, in some instances the initial distribution 111 can correspond to a continuous distribution (e.g., a probability distribution function can be parameterized, such as with learnable parameters).

Block (a) of FIG. 1 also depicts training iterations 106, in which the training system(s) 104 can, for example, train the reference model 102 based on one or more training samples 108. During a training iteration 106, various training or learning techniques can be used, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training steps. In some instances, the training iterations 106 can be adapted to specially train the reference model 102 for a specific application area. In other instances, the training iterations 106 can have a more general-purpose configuration. For instance, the training iterations 106 can use techniques other than backpropagation of errors, such as black box optimization techniques.

Block (b) of FIG. 1 illustrates a portion of the example training sequence of FIG. 1 in which a proxy model 112 and learned distribution parameters 126 are jointly trained using, in part, values(s) from the reference model 102. Block (b) of FIG. 1 contains a proxy model 112, which can be trained by one or more training system(s) 114 over one or more training iterations 116. The training system(s) 114 can sample one or more training samples 120 from the training data 122 based on an initial proxy distribution 124 and can use the training samples 120 for jointly training the proxy model 112 and learned distribution parameters 126. Block (b) also depicts reference data 118, which can be one or more values from the reference model 102 that the training system(s) 114 can use during joint training.

Block (b) of FIG. 1 depicts a proxy model 112. The proxy model 112 can be, for example, a machine-learned model. The proxy model 112 can be or include various different types of machine-learned model architectures. The proxy model 112 can be or include a sequence processing model that is configured to generate one or more output(s) in a sequence based on one or more input(s) in a sequence. In some instances, the proxy model 112 can be a language model, image processing model, audio processing model, etc. In some instances, the proxy model 112 can be, for example, a relatively small machine-learned model, such as a 280-million-parameter model, that can be trained using less time and/or computing power than a larger machine-learned model (e.g., larger by a factor of 5, 10, 20, 30, 50, 100, 200, 1000, etc.). In some instances, the proxy model 112 can be a language model. In some instances, the proxy model 112 can leverage an attention mechanism such as self-attention. For example, the proxy model 112 can be a multi-headed self-attention model (e.g. an encoder-only, encoder-decoder, or decoder-only transformer language model).

The proxy model 112 can have an architecture (e.g. number of parameters, number of layers, model dimension, etc.) that can be the same as or different from an architecture of the reference model 102. The proxy model 112 can be initialized with different weights than reference model 102. The initialized weights can be randomly initialized or otherwise in an un-trained state. The initialized weights can use a prior training checkpoint (e.g., after pre-training, prior to fine-tuning, etc.).

Block (b) of FIG. 1 also depicts one or more training system(s) 114. The training system(s) 114 can be, for example, one or more computing systems configured to train one or more machine-learned models. The training system(s) 114 can be located on a single computing system or distributed across multiple computing systems. In some instances, the training system(s) 114 can correspond to a training computing system 50, as depicted in FIG. 8a. In some instances, the training system(s) 114 can be the same as, be different from, be implemented by, or implement the training system(s) 104.

Block (b) of FIG. 1 also depicts training data 122, from which the training system(s) 114 can, for example, sample one or more training samples 120 to use in one or more training iterations 116. The training data 122 can include, for example, image data or text data.

The training data 122 can include data associated with a plurality of distinct data domains. A data domain can be a subset of the training dataset 122 having identifiable characteristics that distinguish it from another domain. A data domain can be defined by one or more sources from which data was extracted (e.g. legal cases from one or more court systems) or by other characteristics of the data, e.g. by a language associated with the data (e.g. French audio clips, Python code), a method by which the data was collected (e.g. by scraping public domain web data based on one or more popularity scores of one or more internet hyperlinks), or any other metric used to categorize data into distinct domains (e.g. dense data, sparse data). A data domain can be derived from a single source or from multiple sources. In some embodiments, the training data 122 can include one or more public domain datasets containing a mixture of data domains identified by a publisher of the public domain dataset.

In some instances, the training data 122 of block (b) can be identical to the training data 110 of block (a). However, this is not required. Where the training data 122 is not identical to the training data 110, the data domains contained in the training data 122 can be similar to, overlap substantially with, or be identical to the data domains contained in the training data 110.

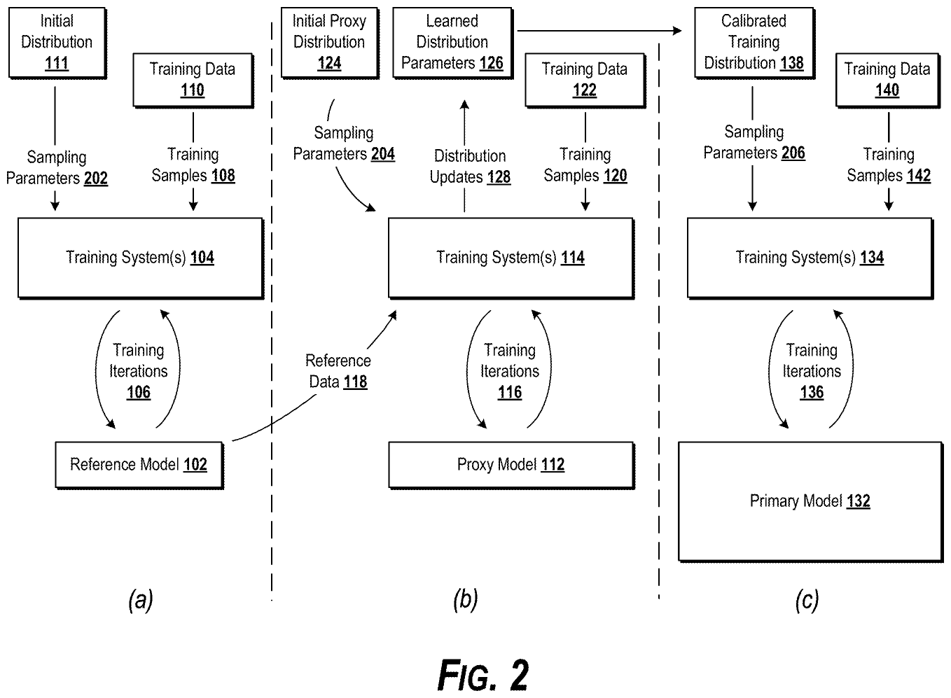

Block (b) of FIG. 1 also depicts an initial proxy distribution 124. The training system(s) 114 can initially select a first batch of training samples 120 according to the initial proxy distribution 124 for a first training iteration 116, such that the distribution of selected training samples 120 approximates the initial proxy distribution 124 within an acceptable margin. In some instances, the training system(s) 114 can continue selecting training samples 120 according to the initial proxy distribution 124 for multiple training iterations 116 or throughout subsequence (b). In some instances, each example of training data 122 can belong to exactly one of a finite number of data domains, and the initial proxy distribution 124 can indicate a discrete set of probabilities, with each data domain having an associated probability or percentage. In other instances, the initial proxy distribution 124 can be more complex. For example, in some instances the initial proxy distribution 124 can correspond to a continuous distribution (e.g., a probability distribution function can be parameterized, such as with learnable parameters). In some instances, the initial proxy distribution 124 can be a uniform distribution over all examples in the training data 122. One example implementation of data sampling by the training system(s) 114 is illustrated in FIG. 2.

Block (b) of FIG. 1 also depicts reference data 118 from the reference model 102. The reference data 118 can be, for example, one or more values generated by the reference model 102 based on training inputs (e.g., training sampled 120) passed to the reference model 102 from the training systems 114 during subsequence (b). In some instances, the reference data 118 can be based on one or more probabilities (e.g., at least a portion of one or more probability distributions) determined by the reference model 102. In some instances, the reference data 118 can be based on a probability generated by the reference model 102 and associated with an expected output or optimal output (e.g., a ground truth token). A person skilled in the art will recognize that other values are possible. For example, the reference data 118 can be a reference output generated by the reference model 102 responsive to processing training sample(s) 120 (e.g., an output value or token selected based on a corresponding score or probability).

Block (b) of FIG. 1 also depicts training iterations 116, in which the training system(s) 114 can, for example, train the proxy model 112 based, at least in part, on reference data 118 from the reference model 102. In some example tests according to the present disclosure, a training iteration 116 can include training the proxy model 112 over a batch of training samples 120. During a training iteration 116, various training or learning techniques can be used, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training steps.

Block (b) of FIG. 1 also depicts one or more learned distribution parameters 126. In some instances, each example of training data 122 can belong to one or more of a finite number of data domains, and the learned distribution parameters 126 can be a discrete set of values respectively associated with the data domains. The values of learned distribution parameters 126 can be associated with a weight or probability associated with the respective domains. The learned distribution parameters 126 can be associated with a discrete or a continuous distribution (e.g., a probability distribution function can be parameterized, such as with learnable parameters).

Block (b) of FIG. 1 also depicts one or more distribution updates 128, in which the training system(s) 114 can update the learned distribution parameters 126. The distribution updates 128 can be performed periodically throughout the training of the proxy model 112, such as one distribution update 128 after every training iteration 116. The distribution updates 128 can be performed periodically throughout the training of the proxy model 112, such as one distribution update 128 after every other training iteration 116, interleaved between model updates to proxy model 112.

The distribution update(s) 128 can be based on a comparison between the reference model 102 the proxy model 112. In some instances, the comparison can include a comparison based on values from the reference model 102 and values from the proxy model 112. In some instances, the comparison can include a domain-by-domain comparison between a performance of the reference model 102 and a performance of the proxy model 112. For example, a comparison can indicate how well the proxy model 112 performed on a given training sample 120 as compared to the reference model 102.

In some examples, the comparison can include an excess loss characterized by a difference between a loss of the reference model 102 and a loss of the proxy model 112. In some instances, the loss can be a negative log likelihood loss. In some instances, the comparison can include a weighted excess loss, wherein a respective learned distribution parameter(s) 126 can be used to weight a comparison corresponding to a respective domain associated with the respective learned distribution parameter(s) 126. For example, computing an excess loss associated with a domain can include computing a sum of differences between negative log-likelihoods of the proxy model 112 and negative log-likelihoods of the reference model 102 for tokens associated with that domain during a training iteration 116.

The learned distribution parameters 126 can be updated so that a weighted excess loss can correspond to (e.g., indicate, approximate, etc.) a worst-case excess loss across domains. For instance, the learned distribution parameters 126 can weight the comparison of the excess loss to amplify error in the domains in which the proxy model 112 performs worse than the reference model 102. In some instances, each distribution update 128 can, for example, multiply a current learned distribution parameter 126 associated with a respective domain by exp(n*lambda(t)), where n is a step size (e.g. one) and lambda(t) is an average per-token excess loss for a respective domain (e.g. a sum over all training samples associated with the respective domain of (proxy negative log likelihood minus reference negative log likelihood), divided by a sum of token lengths over all training samples associated with the respective domain).

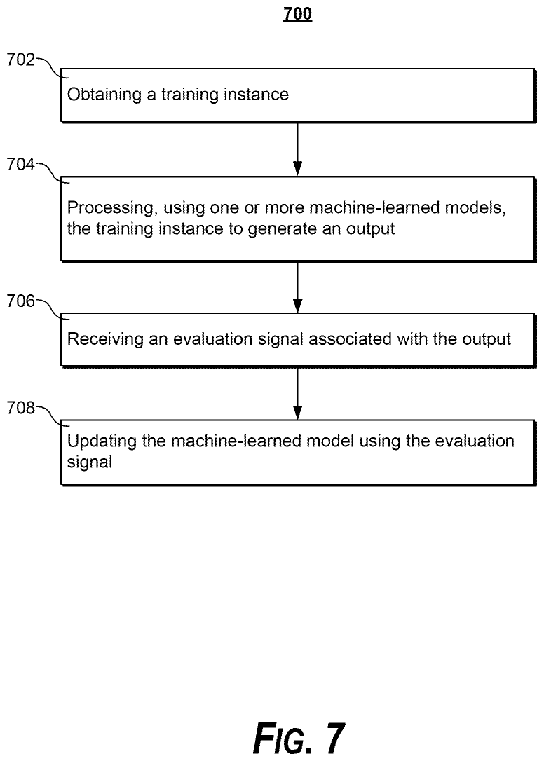

In some instances, the excess loss associated with a respective domain can be a mean excess loss, characterized by a sum of token-by-token excess losses divided by a number of tokens evaluated from the respective domain. In some tests according to the present disclosure, a worst-case excess loss can be approximated by computing a weighted sum of respective excess losses for each respective domain using the learned distribution parameters 126 as weights. In some instances, updating a respective learned distribution parameter 126 associated with a domain can include multiplying the respective learned distribution parameter 126 by a scaling factor based on an excess loss for that domain. In some cases, the scaling factor can be an exponent, such as exp(n*meanExcessLossForDomain), where n can be a constant corresponding to a step size. In some cases, updating learned distribution parameters 126 associated with a domain can include renormalizing, such as by dividing each learned distribution parameter 126 by the sum of learned distribution parameters 126. In some cases, updating learned distribution parameters 126 associated with a domain can include smoothing, such as by multiplying each renormalized learned distribution parameter 126 by (1−c) and adding cu to each respective learned distribution parameter 126, where c can be a smoothing parameter and u can be a respective value associated with a uniform distribution (e.g. 1 divided by a number of data domains, or a number of data examples in an associated data domain divided by a number of data examples in the training data 122). In some instances, a distribution update 128 can include using one or more weight update functions depicted in FIG. 7.

In some instances, the learned distribution parameters 126 can be used during a training iteration 116 as a component of an objective function used to update the proxy model 112. For example, an objective function can be configured for increasing a performance of the proxy model 112. The objective function can be configured to decrease an error of the proxy model 112. The objective function can be configured to cause the training system(s) 114 to update the proxy model 112 to decrease a weighted excess loss of the proxy model 112 over the reference model 102.

In some instances, the objective function can be a sum over all domains of (weight*sum over all training examples in a respective domain of (proxy negative log likelihood minus reference negative log likelihood)), where the weight associated with a respective domain corresponds to a learned distribution parameter 126 associated with the respective domain. For example, the objective for training the proxy model 112 can be to minimize a maximum weighted excess loss (e.g., a minimax objective).

An example minimax objective is provided in equation (1) below.

$${min}_{θ} {max}_{α ∈ {Δ}^{k}} L ( θ , α ) = {min}_{θ} {max}_{α ∈ {Δ}^{k}} {\sum }_{i = 1}^{k} {α}_{i} \cdot [ \frac{1}{{\sum }_{x ∈ {D}_{i}} \vert x \vert} {\sum }_{x ∈ {D}_{i}} {l}_{θ} ( x ) - {l}_{ref} ( x ) ] \qquad ( 1 )$$

where the losses l_θ(x)=−log p_θ(x) and l_ref(x)=−log p_ref(x) can be the negative log-likelihoods of the proxy and reference models respectively, and |x| can be the token length of an example x. In some respects, this objective can minimize the worst-case excess loss across domains because the inner maximization over a puts all the weight on the domain with the highest excess loss.

Example implementations described herein refer to “worst case” excess loss. It is to be understood that other formulations of the loss can be used. For example, an objective can be configured to train the learned distribution parameters 126 to amplify losses over a top-K set of domains of worst performing domains. The objective can be configured to train the learned distribution parameters 126 to amplify losses over one or more domains selected using a separate machine-learned model trained to identify domains that, if weighted, could improve an overall performance (e.g., by training such identifier model end-to-end with the proxy model).

Before or after one or more distribution updates 128, the training system(s) 114 can save a current state or checkpoint corresponding to the current respective values of the learned distribution parameters 126 at the time the current state or checkpoint is saved.

In general, the proxy model 112 can be trained to improve its performance with respect to the reference model. The learned distribution parameters 126 can be learned to amplify the greatest error(s) of the proxy model 112. By amplifying excess losses from low-performance domains, the training objective can induce larger updates to the proxy model 112 with respect to those low-performance domains. In this manner, for instance, the objective can cause the training system(s) 114 to focus on improving the performance of the proxy model 112 in areas in which it needs the most improvement.

This focusing of the training can help proxy model 112 optimally use its parameters to achieve better overall performance. For example, low-complexity or low entropy domains (e.g., an area in which model(s) can be easily performant) can be associated with low excess loss, since the proxy model 112 can quickly learn to match the performance of the reference model 102. As such, the objective can learn lower weights for these domains (e.g., lower learned distribution parameter(s) 126), as those domains need not be amplified. High complexity or high entropy domains (e.g., an area in which model(s) may struggle to be performant) can also be associated with low excess loss, since both the reference model 102 and the proxy model 112 can both struggle to be performant (e.g., for reference model(s) and proxy model(s) that are relatively evenly matched in potential expressive power, such as by sharing an architecture, parameter count, etc.). The objective can thus also learn lower weights for these domains (e.g., lower learned distribution parameter(s) 126), as dedicating disproportionate expressive power to handling those domains may be fruitless or come at too high of a cost for overall model performance. In contrast, however, medium complexity or medium entropy domains (e.g., an area in which a reference model 102 may be performant) can be associated with high excess loss, since the good performance of the reference model 102 can lead the performance of the proxy model 112. The objective can amplify the weight applied to these domains in the loss function, such that model updates can bias the effect of the update(s) to cause proxy model 112 to attend more to its performance in those domains. In this manner, for instance, the bounded expressivity of a machine-learned proxy model can be put to better use to improve performance in areas in which high performance is attainable.

The weighting applied within the objective during training of the proxy model 112 can similarly be used to calibrate a training dataset for training a primary machine-learned model 132. For example, in the objective for training the proxy model 112, the weights can be used to amplify an excess loss to cause the training to focus on a particular domain. Analogously, a weight associated with a respective domain can inform the selection of training data (e.g., a proportion of training data selected from the respective domain) to likewise focus the training of the primary model 132 on that domain.

Block (c) of FIG. 1 illustrates a portion of the example training sequence of FIG. 1 in which a primary model 132 is trained using, in part, a calibrated training distribution 138 based, at least in part, on one or more states of the learned distribution parameters 126 during or after subsequence (b). Block (c) of FIG. 1 contains a primary model 132, which can be trained by one or more training system(s) 134 over one or more training iterations 136. In a respective training iteration, the training system(s) 134 can sample one or more training samples 142 from the training data 140 based on a calibrated training distribution 138.

Block (c) of FIG. 1 depicts a primary model 132. The primary model 132 can be, for example, a machine-learned model. The primary model 132 can be or include various different types of machine-learned model architectures. The primary model 132 can be or include a sequence processing model that is configured to generate one or more output(s) in a sequence based on one or more input(s) in a sequence. In some instances, the primary model 132 can be a language model, image processing model, audio processing model, etc. In some instances, the primary model 132 can be, for example, a relatively large machine-learned model that requires more time, computing power, and/or expense to train than smaller machine-learned models, such as the proxy model 112 and the reference model 102 in some instances. In some instances, the primary model 132 can be much more expensive to train than the reference model 102 and/or proxy model 112 (e.g., by a factor of 5, 10, 20, 30, 50, 100, 200, 500, 1000, etc.). In some instances, this training cost can be associated with a larger number of parameters, a more complex architecture, a larger number of floating-point operations required per update, a higher latency, etc. In some instances, the primary model can be a language model, such as a large language model. In some instances, the primary model 132 can leverage an attention mechanism such as self-attention. For example, the primary model 132 can be a multi-headed self-attention model (e.g. an encoder-only, encoder-decoder, or decoder-only transformer language model). In some example tests according to the present disclosure, the primary model 132 can be an 8-billion-parameter model with 32 layers, 32 attention heads, an attention head dimension of 128, a model dimension of 4096, and a hidden dimension of 24576. A person skilled in the art will recognize that other model sizes (e.g., 100 billion, 500 billion, 1 trillion, 5 trillion parameters, etc.) and configurations are possible.

Block (c) of FIG. 1 also depicts one or more training system(s) 134. The training system(s) 134 can be, for example, one or more computing systems capable of training one or more machine-learned models. The training system(s) 134 can be located on a single computing system or distributed across multiple computing systems. In some instances, the training system(s) 134 can correspond to a training computing system 50, as depicted in FIG. 8a. In some instances, the training system(s) 134 can be the same as, be different from, be implemented by, or implement the training system(s) 104.

Block (c) of FIG. 1 also depicts training data 140, from which the training system(s) 134 can, for example, sample one or more training samples 142 to use in one or more training iterations 136. The training data 140 can include, for example, image data or text data.

The training data 140 can include data associated with a plurality of distinct data domains. A data domain can be a subset of the training dataset 140 having identifiable characteristics that distinguish it from another domain. In some instances, the training data 140 of block (c) can be identical to the training data 122 of block (b). However, this is not required. Where the training data 140 is not identical to the training data 122, the data domains contained in the training data 140 can be similar to, overlap substantially with, or be identical to, the data domains contained in the training data 122.

Block (c) of FIG. 1 also depicts a calibrated training distribution 138. The training system(s) 134 can select training samples 142 according to the calibrated training distribution 138, such that the distribution of selected training samples 142 approximates the calibrated training distribution 138 within an acceptable margin. In some instances, each example of training data 140 can belong to one or more of a finite number of data domains, and the calibrated training distribution 138 can be a discrete set of probabilities or percentages with a sum of 1.0, with each data domain having an associated probability or percentage. In other instances, the calibrated training distribution 138 can be more complex. For example, in some instances the calibrated training distribution 138 can be a continuous distribution (e.g., a probability distribution function can be parameterized with learnable parameters).

The calibrated training distribution 138 can be based on the learned distribution parameters 126. For example, the calibrated training distribution 138 can correspond to one of the checkpoints saved for the learned distribution parameters 126 (e.g., a final checkpoint). The calibrated training distribution 138 can be computed by averaging over one or more checkpoints. The calibrated training distribution 138 can be generated by processing one or more checkpoints with a machine-learned model.

Block (c) of FIG. 1 also depicts training iterations 136, in which the training system(s) 134 can, for example, train the primary model 132 based, at least in part, on a calibrated training distribution 138. In some instances, this can comprise training the primary model 132 using training samples 142 selected according to the calibrated training distribution 138. During a training iteration 136, various training or learning techniques can be used, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training steps.

FIG. 2 depicts a block diagram, with additional detail, of one example implementation of the example training sequence of FIG. 1.

In particular, FIG. 2 depicts sampling parameters 202, sampling parameters 204, and sampling parameters 206, which the training system(s) 104, training system(s) 114, and training system(s) 134 can use to sample training samples 108, training samples 120, and training samples 142 corresponding to the initial distribution 111, initial proxy distribution 124, and calibrated training distribution 138 respectively.

Block (a) of FIG. 2 depicts an initial distribution 111 characterized by a plurality of sampling parameters 202. In some instances, the plurality of sampling parameters 202 can correspond to a plurality of data domains associated with the training data 110, with each respective sampling parameter indicating a probability of sampling from a corresponding data domain. During or prior to one or more training iterations 106, the training system(s) 104 can, for example, sample a batch of items from the training data 110 based on the sampling parameters 202 such that a percentage of items sampled from each domain corresponds to a respective sampling parameter 202 for that domain.

The sampling parameters 202 associated with the initial distribution 111 can be, for example, a plurality of fixed probabilities. In some instances, the initial distribution 111 can correspond, for example, to a uniform distribution over all examples in the training data 110. In other instances, the sequence depicted in FIG. 1 can be performed more than once, and the initial distribution 111 of later iterations of the sequence can correspond to a calibrated training distribution 138 computed in earlier iterations. (And reference model 102 can be replaced by the trained proxy model 112.) In other instances, the initial distribution 111 can be heuristically determined (e.g., based on predictions of estimated qualities of various domains, such as estimated complexity, estimated utility, etc.) or based on a published distribution.

Block (b) of FIG. 2 depicts an initial proxy distribution 124 characterized by a plurality of sampling parameters 204.

In some instances, the plurality of sampling parameters 204 can correspond to a plurality of data domains associated with the training data 122, with each respective sampling parameter indicating a probability of sampling from a corresponding data domain. During or prior to one or more training iterations 116, the training system(s) 114 can, for example, sample a batch of items from the training data 122 such that a percentage of items sampled from each domain corresponds, at least in part, to a current value of a respective sampling parameter 204 for that domain.

The sampling parameters 204 associated with the initial proxy distribution 124 can be, for example, a plurality of fixed probabilities corresponding to a plurality of data domains. For example, the sampling parameters 204 can be held constant while training proxy model 112. For instance, learned distribution parameters 126 can be used to weight the loss(es) in the objective function while sampling parameters 204 remain fixed. However, a person skilled in the art will recognize that other possibilities exist, such as a plurality of updatable probabilities with respective initial values. For example, the learned distribution parameters 126 can be used to sample new training samples 120 for subsequent training iterations 116.

The respective probabilities or initial values can correspond, for example, to a uniform distribution over all examples in the training data 122. In some instances, the sampling parameters 204 can be the same as or different from the sampling parameters 202 associated with the initial distribution 111 (e.g. non-uniform sampling parameters 202, uniform sampling parameters 204).

Block (c) of FIG. 2 depicts a calibrated training distribution characterized by a plurality of sampling parameters 206.

In some instances, the plurality of sampling parameters 206 can correspond to a plurality of data domains associated with the training data 140, with each respective sampling parameter 206 indicating a probability of sampling from a corresponding data domain. During or prior to one or more training iterations 136, the training system(s) 134 can, for example, sample a batch of items from the training data 140 based on the sampling parameters 206 such that a percentage of items sampled from each domain corresponds to the respective sampling parameter 206 for that domain.

The sampling parameters 206 associated with the calibrated training distribution 138 can be, for example, a plurality of fixed probabilities. The calibrated training distribution 138 can be, for example, based on one or more checkpoints of the learned distribution parameters 126 saved during subsequence (b). In some examples, the value of each respective sampling parameter 206 of the calibrated training distribution 138 can be equal to a final value (i.e. a value after subsequence (b) is fully performed) of a learned distribution parameter 126 corresponding to the same data domain. In other instances, each respective sampling parameter 206 of the calibrated training distribution 138 can be based on an average or weighted average of one or more learned distribution parameters 126 corresponding to the same data domain and associated with one or more learned distribution parameter 126 checkpoints. In some cases, the calibrated training distribution 138 can be a smoothed and/or renormalized average of one or more learned distribution parameter 126 checkpoints. A person skilled in the art will recognize other variants of the techniques described herein.

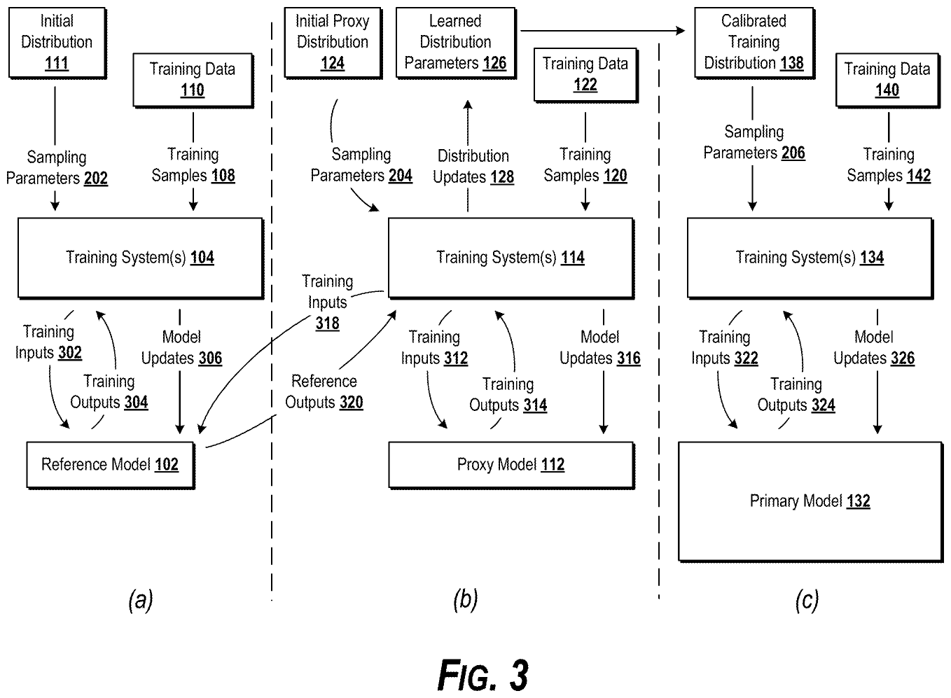

FIG. 3 depicts a block diagram, with additional detail, of one example implementation of the example training sequence of FIGS. 1 and 2.

In particular, FIG. 3 depicts one example implementation of the training iterations 106, training iterations 116, and training iterations 136 depicted in FIG. 1 blocks (a), (b), and (c) respectively.

Block (a) of FIG. 3 depicts a training system(s) 104 sending training inputs 302 to a reference model 102, receiving training outputs 304 from the reference model 102, and performing model updates 306 on the reference model 102.

Each training input 302 can, for example, correspond to all or part of a corresponding training sample 108. In some instances, each training sample 108 can include both a training input 302 and a value corresponding to an expected output, optimal output, or training data label. In some instances, the value of the expected output can correspond, for example, to a masked token or next token that is present in the training sample 108 but excluded (e.g. masked) from processing by the model (e.g., excluded from the training input 302, masked in an attention mask, etc.).

In each training iteration 106, the training system(s) 104 can, for example, input one or more (e.g. 512) training inputs 302 to the reference model 102. The reference model 102 can then, for example, output one or more training outputs 304 based on the training inputs 302 and the current state of the reference model 102. In some instances, the training system(s) 104 can compare one or more training outputs 304 to one or more expected outputs, optimal outputs, or training data labels corresponding to a respective training sample 108. In some instances, the training system 104 can compare one or more internal states, scores, probabilities, or other output values generated by the reference model 102 to a ground truth value. For example, a ground truth value can be or correspond to a ground truth portion of the training input 302. For example, a ground truth value can be a one-hot vector across an output vocabulary indicating the actual output portion in the training input 302. This can be compared to an output distribution of the reference model 102. For example, a layer of the reference model 102 can generate a score or probability associated with the actual output portion. The reference model 102 may or may not assign a highest probability or score to that actual output portion. For instance, the reference model 102 might assign a higher probability to another output portion (e.g., another word in an output vocabulary) or otherwise select another output portion. A negative log likelihood can be a loss used to characterize a performance of the reference model 102 for a respective training input 302. An accumulation of losses or other metrics over all the training inputs 302 from a training sample 108 can represent a performance of the reference model 102 on the training sample 108.

During the subsequence depicted in Block (a) of FIG. 3, the training system(s) 104 can perform one or more model updates 306, in which the training system(s) 104 modifies the current state of the reference model 102. In some instances, the training system(s) 104 can perform a model update 306 after each training iteration 106. In other instances, the training system(s) can perform a model update 306 periodically, after a plurality of training iterations 106 has been performed.

Block (b) of FIG. 3 depicts a training system(s) 114 sending training inputs 312 to a proxy model 112 and sending training inputs 318 to a reference model 102. The training system(s) 114 can also receive training outputs 314 and reference outputs 320 from the proxy model 112 and reference model 102 respectively. The training system(s) 114 is also depicted performing one or more model updates 316.

Each training input 312 can, for example, correspond to a portion of a corresponding training sample 120. In some instances, each training sample 120 can include both a training input 312 and a value corresponding to an expected output, optimal output, or training data label. In some instances, the value of the expected output can correspond, for example, to a masked token or next token that is present in the training sample 108 but excluded (e.g. masked) from processing by the model (e.g., excluded from the training input 302, masked in an attention mask, etc.).

In some instances, the value of the expected output can correspond, for example, to a masked token or next token that is present in the training sample 120 but excluded (e.g. masked) from the training input 312. In some instances, a training input 312 can be identical to a corresponding training input 318.

In each training iteration 116, the training system(s) 114 can, for example, input one or more training inputs 312 to the proxy model 112. The proxy model 112 can then, for example, output one or more training outputs 314 based on the training inputs 312 and a current state of the proxy model 112. In some instances, the training system(s) can compare one or more training outputs 312 to one or more expected outputs, optimal outputs, or training data labels corresponding to a respective training sample 120. In some instances, the training system 114 can perform masked language modeling by comparing a ground truth value to one or more likelihood outputs for a masked token or next token and computing a language modeling loss (e.g. negative log likelihood) associated with a respective training sample 120.

In some instances, the training system 114 can compare one or more internal states, scores, probabilities, or other output values generated by the proxy model 112 to a ground truth value. For example, a ground truth value can be or correspond to a ground truth portion of the training input 312. For example, a ground truth value can be a one-hot vector across an output vocabulary indicating the actual output portion in the training input 312. This can be compared to an output distribution of the proxy model 112. For example, a layer of the proxy model 112 can generate a score or probability associated with the actual output portion. The proxy model 112 may or may not assign a highest probability or score to that actual output portion. For instance, the proxy model 112 might assign a higher probability to another output portion (e.g., another word in an output vocabulary) or otherwise select another output portion. A negative log likelihood can be a loss used to characterize a performance of the proxy model 112 for a respective training input 312. An accumulation of losses or other metrics over all the training inputs 312 from a training sample 120 can represent a performance of the proxy model 112 on the training sample 120.

During the subsequence depicted in Block (b) of FIG. 3, the training system(s) 114 can perform one or more model updates 316, in which the training system(s) 114 modifies parameters of the proxy model 112. In some instances, the training system(s) 114 can perform model updates 316 periodically, after each of one or more training iterations 116 has been performed. In other instances, the training system(s) 114 can perform multiple model updates 316 per training iteration 116 or perform multiple training iterations 116 between model updates.

Additionally, in each training iteration 116, the training system(s) 114 can, for example, input one or more training inputs 318 to the reference model 102. The training inputs 318 can optionally be identical to the training inputs 312, but this is not required. Where the training inputs 318 are not identical to the training inputs 312, the data domains represented in the training inputs 318 can overlap substantially with, or be identical to, the data domains represented in the training inputs 312. The reference model 102 can then, for example, output one or more reference outputs 320 based on the training inputs 318 and a current state of the reference model 102.

For example, the training system(s) 114 can, for example, input one or more training inputs 318 to the reference model 102. The reference model 102 can then, for example, output one or more reference outputs 320 based on the training inputs 318 and a current state of the reference model 102. In some instances, the training system(s) 114 can use the reference output(s) 320 to compare a performance of the reference model 102 against the proxy model 112 for a given training sample 120. The training system(s) 114 can directly compare reference output(s) 320 to training output(s) 314. The training system(s) 114 can compare values computed using the reference output(s) 320 to values computed using the training output(s) 314.

For example, the training system(s) 114 can compare one or more reference outputs 320 to one or more expected outputs, optimal outputs, or training data labels corresponding to a respective training sample 120. In some instances, the training system 114 can perform masked language modeling by comparing a ground truth value to one or more likelihood outputs for a masked token or next token and computing a language modeling loss (e.g. negative log likelihood) associated with a respective training input 318 from a training sample 120.

In some instances, the training system 114 can compare one or more internal states, scores, probabilities, or other output values generated by the reference model 102 to a ground truth value. For example, a ground truth value can be or correspond to a ground truth portion of the training input 312. For example, a ground truth value can be a one-hot vector across an output vocabulary indicating the actual output portion in the training input 312. This can be compared to an output distribution of the reference model 102. For example, a layer of the reference model 102 can generate a score or probability associated with the actual output portion. The reference model 102 may or may not assign a highest probability or score to that actual output portion. For instance, the reference model 102 might assign a higher probability to another output portion (e.g., another word in an output vocabulary) or otherwise select another output portion. A negative log likelihood can be a loss used to characterize a performance of the reference model 102 for a respective training input 312. An accumulation of losses or other metrics over all the training inputs 312 from a training sample 120 can represent a performance of the reference model 102 on the training sample 120.

In this manner, for instance, the training system(s) 114 can compare a performance of the reference model 102 and the proxy model 112 over a given training sample 120.

Pseudocode for jointly learning distribution parameters during training of a proxy model according to some example tests according to the present disclosure is presented in Algorithm 1.

Algorithm 1

```
Require: Domain data D₁, . . . , Dₖ, number of training steps T, batch size b, step size η,
  smoothing parameter c ∈ [0, 1] (e.g., c = 1e-4 in one implementation).
  Initialize proxy weights θ₀
  $Initialize domain weights {α}_{0} = \frac{1}{k} 1$
  for t from 1 to T do
    $Sample minibatch B = \{ {x}_{1} , … , {x}_{j} \} of size b from {P}_{u} , where u = \frac{1}{k} 1$
    Let |x| be the token length of example x (|x| ≤ L)
    Compute per-domain excess losses for each domain i ∈ {1, 2, . . . , k} (l_{θ,j}(x) is j-th token
level loss):
      ${λ}_{t} [ i ] ← \frac{1}{{\sum }_{x ∈ B ⋂ {D}_{i}} \vert x \vert} {\sum }_{x ∈ B ⋂ {D}_{i}} {\sum }_{j = 1}^{\vert x \vert} max \{ {l}_{{θ}_{t - 1} , j} ( x ) - {l}_{ref , j} ( x ) , 0 \}$
      Update domain weights (exp is entrywise): α′ₜ ← αₜ₋₁ exp (ηλₜ)
      $Renormalize and smooth domain weights : {α}_{t} ← ( 1 - c ) \frac{{{α}^{′}}_{t}}{{\sum }_{i = 1}^{k} {{α}^{′}}_{t} [ i ]} + c u$
      Update proxy model weights θₜ for the objective L(θₜ₋₁, αₜ) (using Adam, Adafactor, etc.)
  end for
  $return \frac{1}{T} {\sum }_{t = 1}^{T} {α}_{t}$
```

For example, in some example tests according to the present disclosure, a plurality of proxy weights and a plurality of initial domain weights can be initialized. In some instances, a series of T (e.g. 200,000) training steps (e.g. training iterations 116) can be performed. In some instances, a training step can include sampling a minibatch B of training examples (e.g. training samples 120) according to a uniform distribution. In some instances, a training step can further include computing per-domain excess losses for each data domain according to equation. In some instances, a training step can further include renormalizing and smoothing domain weights using a value u obtained from a uniform distribution. In some instances, a training step can further include updating proxy model weights to optimize an objective function, which can be based on one or more updated domain weights. In some instances, computing the objective function can include multiplying a loss (e.g., language modeling loss, such as a negative log likelihood loss) by a respective updated domain weight associated with a respective domain and training step. In some instances, a respective updated domain weight can include a learned distribution parameter 126. In some instances, a calibrated training distribution 138 can be computed by: storing, for each respective data domain and for each respective training step, a respective updated domain weight; and computing an average, for a respective domain and over all training steps, of updated domain weights associated with the respective domain.

Block (c) of FIG. 3 depicts a training system(s) 134 sending training inputs 322 to a primary model 132 and receiving training outputs 324 from the primary model 132. The training system(s) 134 is also depicted performing model updates 326 on the primary model 132.

Each training input 322 can, for example, correspond to a portion of a corresponding training sample 142. In some instances, each training sample 142 can include both a training input 322 and a value corresponding to an expected output, optimal output, or training data label. In some instances, the value of the expected output can correspond, for example, to a masked token or next token that is present in the training sample 142 but excluded (e.g. masked) from the training input 322.

In each training iteration 136, the training system(s) 134 can, for example, input one or more training inputs 322 to the primary model 132. The primary model 132 can then, for example, output one or more training outputs 324 based on the training inputs 322 and the current state of the primary model 132. In some instances, the training system(s) 134 can compare one or more training outputs 324 to one or more expected outputs, optimal outputs, or training data labels corresponding to a respective training sample 142. In some instances, the training system 134 can perform masked language modeling by comparing a ground truth value to one or more likelihood outputs for a masked token or next token and computing a language modeling loss (e.g. negative log likelihood) associated with a respective training sample 142.

During the subsequence depicted in Block (c) of FIG. 3, the training system(s) 134 can perform one or more model updates 326, in which the training system(s) 134 modifies the current state of the primary model 132. In some instances, the training system(s) 134 can perform a model update 326 after each training iteration 136. In other instances, the training system(s) 134 can perform multiple model updates 326 per training iteration or can perform a model update 326 periodically, after one or more batches of training iterations 136 has been performed.

### Example Tests

In some example tests according to the present disclosure, a small (e.g., 280 million parameters) reference model can be trained using a dataset comprising a plurality of data domains. The reference model can be, for example, a language model. In some instances, the reference model can be an attention-based model such as a multi-headed self-attention model (e.g. transformer model).

Next, a small (e.g., 280 million parameters) proxy model can be trained using the same dataset. In some instances, the proxy model can be trained using a form of distributionally robust optimization (DRO). In some instances, the distributionally robust optimization can be an online learning-based optimizer for training a group DRO model. In some instances, the proxy model can be trained to minimize a worst-case excess loss across domains, wherein an excess loss is defined by a difference between a loss of the reference model and a loss of the proxy model with respect to the same domain. In some instances, the worst-case excess loss associated with a domain can be an average per-token excess loss (e.g., a total excess loss divided by a token count).

In some example tests according to the present disclosure, training the proxy model can include dynamically updating domain weights according to the loss on each domain for rescaling the training objective. In some instances, the training process can include interleaving exponentiated gradient ascent updates on one or more domain weights with gradient updates on one or more proxy model weights. In some instances, the domain weight updates can upweight domains with high excess loss relative to the reference model, which scales up the proxy model's gradient update on examples from these domains.

At one or more times during training of the proxy model, one or more current values of the dynamically updated domain weights can be stored. For example, in some instances, the proxy model can be trained for 200,000 training steps with a batch size of 512 data examples. (A person skilled in the art will recognize that other numbers of training steps and batch sizes are possible, e.g., 300,000 or 75,000.) In such instances, a current value of the dynamically updated domain weights can be stored at the end of each training step.

In some example tests according to the present disclosure, one or more stored domain weight values can be used to compute a probability distribution. For example, in some instances, each data domain from a plurality of data domains can have an associated domain weight at each training step. Each stored domain weight value can be a value between zero and one, such that the sum of domain weight values over all domains can be equal to one at the end of a respective training step. In some instances, each domain can be associated with a plurality of stored domain weight values corresponding to that domain's weight at the end of each of a plurality of training steps. In some instances, a probability distribution can include a weight assigned to each domain in a plurality of data domains, such that each domain is associated with a probability corresponding to an average of that domain's stored weight values across a plurality of training steps.

In some example tests according to the present disclosure, a large (e.g., more than 30 times as many parameters as the proxy and reference model, e.g., 8 billion parameters) primary model can be trained using the computed calibrated training distribution 138, wherein a probability of selecting a training sample from a particular domain can correspond to a probability associated with that domain in the calibrated training distribution 138.

In some tests, systems and methods of the present disclosure improved downstream accuracy of an 8-billion-parameter primary model by 6.5 percentage points over a baseline 8-billion-parameter model trained on the same dataset using default probability distributions. Additionally, the baseline model achieved its maximum accuracy after 200,000 training steps, while the primary model achieved the same accuracy within 75,000 training steps—2.6 times faster than the baseline.

Additionally, in some tests, systems and methods of the present disclosure reduced perplexity across all domains, including domains where a sampling probability was reduced relative to the baseline.

In other example tests according to the present disclosure, a second reference model can be trained using the computed probability distribution, wherein a probability of selecting a training sample from a particular domain can correspond to a probability associated with that domain in the computed probability distribution. In such instances, a second proxy model can be trained using distributionally robust optimization, and the associated domain weights can be used to compute a second probability distribution. In such instances, the process can be repeated n times, until the nth and (n−1)th probability distribution converge (e.g. differ by less than 1e-3 across all domains). After the probability distributions converge, a primary model can be trained using a converged probability distribution.

In some example tests, a converged probability distribution according to the present disclosure was compared to a probability distribution derived from fine-tuning on specific downstream tasks—a much more expensive training process than the methods of the present disclosure. The converged probability distribution was similar to the downstream-tuned probability distribution, with most domains being upweighted or downweighted to a similar degree in both distributions.

In some example tests according to the present disclosure, other model sizes can be tested. For example, the proxy model, reference model, and primary model can all be the same size (e.g. all three models can be 280 million, 510 million, 760 million, or 1 billion parameters). In such tests, systems and methods of the present disclosure can consistently improve downstream accuracy over baseline by 2 percent and can achieve a baseline model's peak accuracy in 4 times fewer training iterations on average. Systems and methods of the present disclosure can improve worst-case perplexity across all scales, and can improve perplexity in an average of 80 percent of domains in some datasets. Additionally, in example tests where a proxy model and primary model were the same size, the primary model consistently outperformed the proxy model, suggesting that systems and methods of the present disclosure can outperform pure group DRO, even in conditions where group DRO performs well.

In some example tests according to the present disclosure, other proxy model sizes (e.g., 70 million, 150 million, 280 million, and 1 billion parameters) can be tested while keeping a primary model size constant (e.g. 8 billion parameters). In such tests, systems and methods of the present disclosure showed improvement over baseline for all proxy model sizes. In such tests, the largest improvement was associated with a 280 million parameter proxy model (about 30× smaller than the primary model).

In some example tests according to the present disclosure, an excess-loss-based optimization method was compared to methods that optimized by upweighting domains with either high log-perplexity or low log-perplexity, without the use of a reference model. In such tests, an excess-loss-based method according to the present disclosure outperformed either method that did not use a reference model.

Further test results and additional details of the test setup are provided in Xie et al., DoReMi: Optimizing Data Mixtures Speeds Up Language Model Pretraining, arXiv:2305.10429v2 (May 24, 2023), which is hereby incorporated by reference herein in its entirety.

### Example Methods

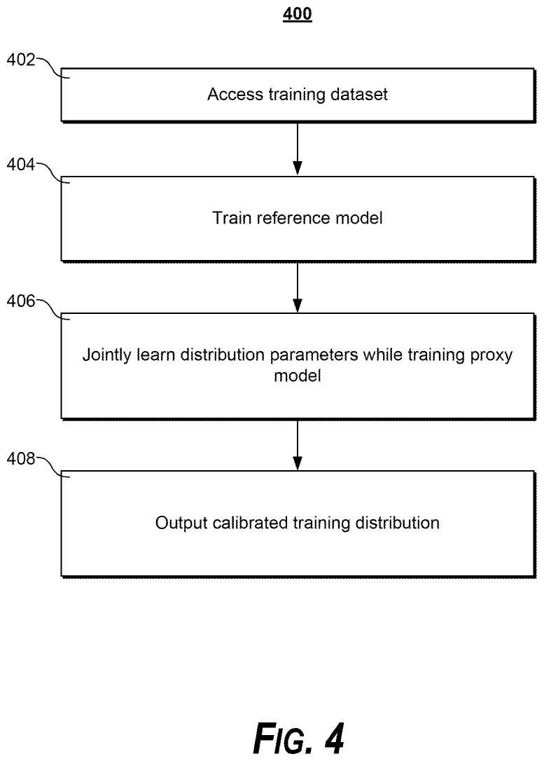

FIGS. 4 through 6 depict flow chart diagrams of example methods 400, 500, and 600 to perform according to example embodiments of the present disclosure. Example methods 400 through 600 can be implemented by one or more computing systems (e.g., one or more computing systems as discussed with respect to FIGS. 1 to 16). Although FIGS. 4 through 6 depict steps performed in a particular order for purposes of illustration and discussion, the methods of the present disclosure are not limited to the particularly illustrated order or arrangement. The various steps of example methods 400 through 600 can be omitted, rearranged, combined, and/or adapted in various ways without deviating from the scope of the present disclosure.

FIG. 4 depicts a flow chart diagram of an example method 400 for learning a calibrated training distribution, in which a proxy model and a plurality of learned distribution parameters can be trained based on a reference model.

In some implementations, at 402 method 400 can include accessing a training dataset characterized by a plurality of data domains. In some instances, the training dataset can be training data 110, 122, 140, etc.

In some implementations, at 404 method 400 can include training a reference model, such as reference model 102. In some instances, the reference model can be trained using a first batch of training examples, the first batch of training examples sampled from the training dataset according to an initial probability distribution over the plurality of data domains. In some instances, the initial probability distribution can be an initial distribution 111 and the training examples can be training samples 108.

In some implementations, at 406 method 400 can include jointly learning distribution parameters while training a proxy model, such as proxy model 112. In some instances, the distribution parameters can be learned distribution parameters 126. In some instances, step 406 can include one or more training iterations 116 or one or more distribution updates 128. In some instances, the proxy model 112 can be trained using a second batch of training examples, the second batch of training examples sampled from the training dataset according to a proxy probability distribution over the plurality of data domains (e.g. an initial proxy distribution 124).

In some instances, step 406 can include training the proxy model by evaluating, for a respective training iteration, a comparison between the reference model and the proxy model, wherein the comparison is evaluated using a plurality of learned distribution parameters. In some instances, the comparison can comprise a domain-by-domain comparison between a performance of the reference model and a performance of the proxy model.

In some instances, the plurality of learned distribution parameters 126 can be used for weighting the comparison between the reference model 102 and the proxy model 112. In some instances, the comparison can include a weighted excess loss (e.g. weighted negative log likelihood excess loss) of the proxy model 112, wherein the learned distribution parameters 126 can be used as weights.

In some instances, the plurality of learned distribution parameters 126 can be learned based on the comparison between the reference model 102 and the proxy model 112. In some instances, step 406 can include updating the proxy model 112 to change the comparison in a first direction and updating the plurality of learned distribution parameters 126 to change the comparison in a second, different direction. In some instances, step 406 can include updating the plurality of learned distribution parameters 126 to amplify a difference metric computed between the reference model 102 and the proxy model 112 and updating the proxy model 112 to decrease the difference metric computed between the reference model 102 and the proxy model 112.

In some example embodiments of the present disclosure, the learned distribution parameters 126 can be updated to amplify a weighted excess loss such that the weighted excess loss approximates a worst-case excess loss across domains, where computing an excess loss associated with a domain can include computing a sum of differences between negative log-likelihoods of the proxy model 112 and negative log-likelihoods of the reference model 102 for tokens associated with that domain during a training iteration 116. In some instances, step 406 can include, for example, multiplying a current learned distribution parameter 126 associated with a respective domain by exp(n*lambda(t)), where n is a step size (e.g. one) and lambda(t) is an average per-token excess loss for a respective domain (e.g. a sum over all training samples associated with the respective domain of (proxy negative log likelihood minus reference negative log likelihood), divided by a sum of token lengths over all training samples associated with the respective domain). In some embodiments, step 406 can include smoothing and/or renormalizing the updated learned distribution parameters 126. In some embodiments, the proxy model 112 can then be updated to decrease an objective function computed using the updated learned distribution parameters 126 as weights. In some instances, the objective function can correspond to a weighted excess loss. In some instances, the objective function can be a sum over all domains of (weight*sum over all training examples in a respective domain of (proxy negative log likelihood minus reference negative log likelihood)), where the weight associated with a respective domain corresponds to a learned distribution parameter 126 associated with the respective domain. In some instances, step 406 can include using one or more weight update functions and/or loss functions depicted in FIG. 7, which will be described in more detail below.

In some instances, step 406 can include evaluating the comparison between the reference model 102 and the proxy model 112 by determining a plurality of difference metrics respectively for the plurality of data domains; weighting the plurality of difference metrics respectively using the plurality of learned distribution parameters 126; and aggregating the weighted plurality of difference metrics. In some instances, determining a plurality of difference metrics respectively can include a comparison between values generated by the reference model 102 for training inputs from the respective domain, and values generated by the proxy model 112 for training inputs from the respective domain. In some instances, the respective difference metric can include an excess loss of the proxy model 112 as compared to the reference model 102. In some instances, the values generated by the proxy model 112 for the training inputs from the respective domain can correspond to predictions associated with designated outputs. In some instances, a designated output can correspond to a ground truth token.

In some instances, step 406 can include jointly learning the plurality of learned distribution parameters using distributionally robust optimization (DRO) over the plurality of data domains.

In some implementations, at 408 method 400 can include outputting a calibrated training distribution 138 over the plurality of data domains based on the plurality of learned distribution parameters 126.

In some implementations, step 406 can include generating a training trajectory that accumulates a plurality of states for the plurality of learned distribution parameters 126, and step 408 can include determining the calibrated training distribution 138 based on the plurality of states. In some instances, determining the calibrated training distribution 138 based on the plurality of states can include one or more of: determining an average of the plurality of states; determining a weighted average of the plurality of states; or determining a representative value of a cluster of the plurality of states.

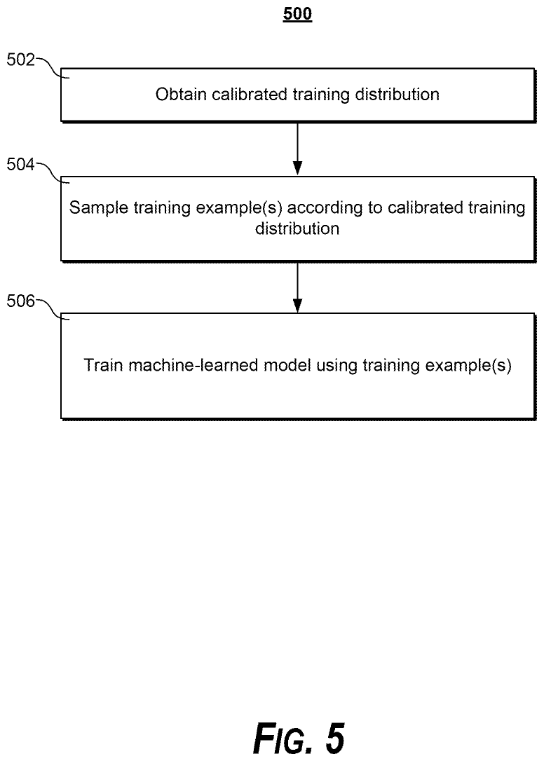

FIG. 5 depicts a flow chart diagram of an example method 500 for training a machine-learned model based on a calibrated training distribution, in which training examples can be sampled from a training dataset based on the calibrated training distribution.

In some implementations, at 502 method 500 can include obtaining a calibrated training distribution 138. In some instances, obtaining the calibrated training distribution 138 can include learning the calibrated training distribution 138 (e.g. according to systems and methods discussed with respect to FIGS. 1 through 4). In other instances, a calibrated training distribution 138 can be obtained in other ways (e.g. receiving a calibrated training distribution 138 from another computing system or person, accessing a calibrated training distribution 138 stored on one or more non-transitory computer-readable media, etc.).

In some implementations, at 504 method 500 can include sampling training example(s) according to the calibrated training distribution 138. In some instances, these training example(s) can be training samples 142.

In some implementations, at 506 method 500 can include training a machine-learned model using the training example(s). In some instances, the machine-learned model can be a primary model 132. In some instances, the calibrated training distribution 138 may have been trained using a proxy model 112. In some implementations, training the machine-learned model can be computationally more expensive than training the proxy model 112. In some instances, the machine-learned model can be characterized by a first number of parameters, the proxy model can be characterized by a second number of parameters, and the first number of parameters can be at least ten times the second number of parameters (e.g. 280-million-parameter proxy model, 8 billion parameter primary model 132). In some instances, the first number of parameters can be at least 30 times the second number of parameters (e.g. 70-million-parameter proxy model, 8-billion-parameter primary model 132). In some instances, the machine-learned model can be trained using a first training task, which can be different from a second training task used to train the proxy model 112. In some instances, a training iteration of the machine-learned model can include executing a first number of floating-point operations and a training iteration of the proxy model 112 can include a second number of floating-point operations that is fewer than the first number of floating-point operations.

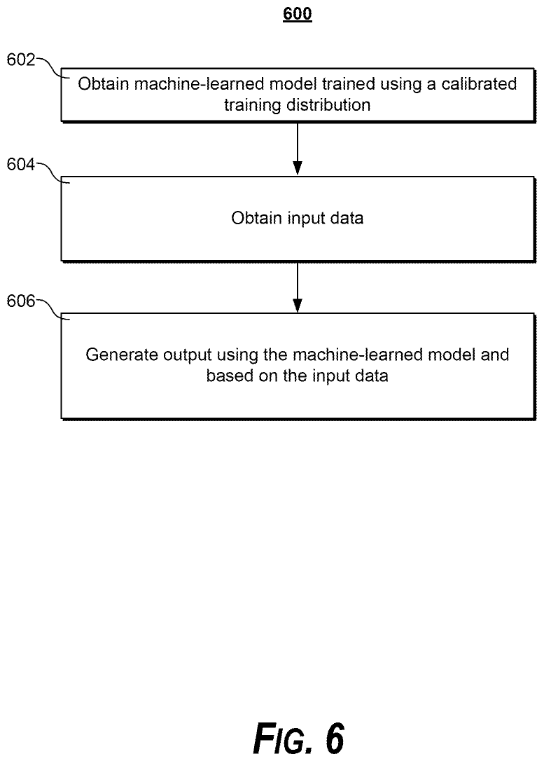

FIG. 6 depicts a flow chart diagram of an example method 600 for using a machine-learned model, which was trained based on a calibrated training distribution, to generate an output.

In some implementations, at 602 method 600 can include obtaining a machine-learned model that was trained using a calibrated training distribution 138. In some instances, the machine-learned model can be a primary model 132. In some instances, obtaining a machine-learned model can include training the machine-learned model (e.g. according to systems and methods discussed with respect to FIGS. 1-5). In other instances, obtaining a machine-learned model can include other methods (e.g. receiving, from another computing system or person, a machine-learned model that was trained using a calibrated training distribution 138; accessing a machine-learned model that was trained using a calibrated training distribution 138 stored on one or more non-transitory computer-readable media, etc.)

In some implementations, at 604 method 600 can include obtaining input data. The input can include any computer-readable input data (e.g. image data or text data). The input data can include, for example, data from a single data domain or a plurality of data domains. In some instances, the input data can include data from a data domain associated with one or more of the training data 110, training data 122, and training data 140. In some instances, the input data can include data from a data domain not associated with any of the training data 110, training data 122, and training data 140.

In some implementations, at 606 method 600 can include generating output data using the machine-learned model and based on the input data. The input can include any computer-appropriate output data (e.g. image data or text data). In some instances, output data can include one or more data types that are the same as or different from one or more data types associated with the input data (e.g. text input with binary or numerical output, image input with image output, text input with image output, etc.). In some instances, the output data can include data associated with a data domain associated with one or more of the training data 110, training data 122, and training data 140. In some instances, the output data can include data not associated with any data domain associated with any of the training data 110, training data 122, and training data 140.

FIG. 7 depicts a flowchart of a method 700 for training one or more machine-learned models according to aspects of the present disclosure. For instance, an example machine-learned model can include a reference model 102, proxy model 112, or primary model 132. In some instances, training iterations 106, 116, and 136 can include one or more steps described with respect to FIG. 7.

One or more portion(s) of example method 700 can be implemented by a computing system that includes one or more computing devices such as, for example, computing systems described with reference to the other figures (e.g. training systems 104, 114, 134). Each respective portion of example method 700 can be performed by any (or any combination) of one or more computing devices. Moreover, one or more portion(s) of example method 700 can be implemented on the hardware components of the device(s) described herein, for example, to train one or more systems or models. FIG. 7 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 7 is described with reference to elements/terms described with respect to other systems and figures for exemplary illustrated purposes and is not meant to be limiting. One or more portions of example method 700 can be performed additionally, or alternatively, by other systems.

At 702, example method 700 can include obtaining a training instance. A training instance can be, for example, a training sample 108, training sample 120, or training sample 142. A training instance can include, for example, a training input 302, training input 312, or training input 322. A set of training data (e.g. training data 110, 122, 140) can include a plurality of training instances divided between multiple datasets (e.g., a training dataset, a validation dataset, or testing dataset). In some instances, obtaining a training instance can comprise sampling a training instance from a set of training data, e.g. based on one or more sampling parameters 202, 204, or 206, or based on an initial distribution 111, initial proxy distribution 124, or calibrated training distribution 138. A training instance can be labeled or unlabeled. Although referred to in example method 700 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 704, example method 700 can include processing, using one or more machine-learned models, the training instance to generate an output. The output can be, for example, a training output 304, training output 314, or training output 324. The output can be directly obtained from the one or more machine-learned models or can be a downstream result of a chain of processing operations that includes an output of the one or more machine-learned models.

At 706, example method 700 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 708, example method 700 can include updating the machine-learned model using the evaluation signal. Updating the machine-learned model using the evaluation signal can include performing a model update 306, model update 316, model update 326, or a distribution update 128. For example, values for parameters (e.g. learned distribution parameters 126) of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 700 can include implementing a number of generalization techniques (e.g., weight decays, dropouts, etc.) to improve the generalization capability of the models being trained.

In some implementations, example method 700 can be implemented for training a machine-learned model from an initialized state to a fully trained state (e.g., when the model exhibits a desired performance profile, such as based on accuracy, precision, recall, etc.).

In some implementations, example method 700 can be implemented for particular stages of a training procedure. For instance, in some implementations, example method 700 can be implemented for pre-training a machine-learned model. Pre-training can include, for instance, large-scale training over potentially noisy data to achieve a broad base of performance levels across a variety of tasks/data types. In some implementations, example method 700 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

### Example Machine-Learned Models

FIG. 8 is a block diagram of an example processing flow for using machine-learned model(s) 1 to process input(s) 2 to generate output(s) 3.

Machine-learned model(s) 1 can be or include one or multiple machine-learned models or model components. Machine-learned model(s) 1 can be or include a reference model 102, a proxy model 112, or a primary model 132. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV:2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data. Inputs 2 can include training inputs 302, 312 or 322; outputs 3 can include training outputs 304, 314, and 324. Outputs 3 can include reference data 118. A training sample 108, 120, 142 can include, for example, an input 2.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

### Example Machine-Learned Sequence Processing Models

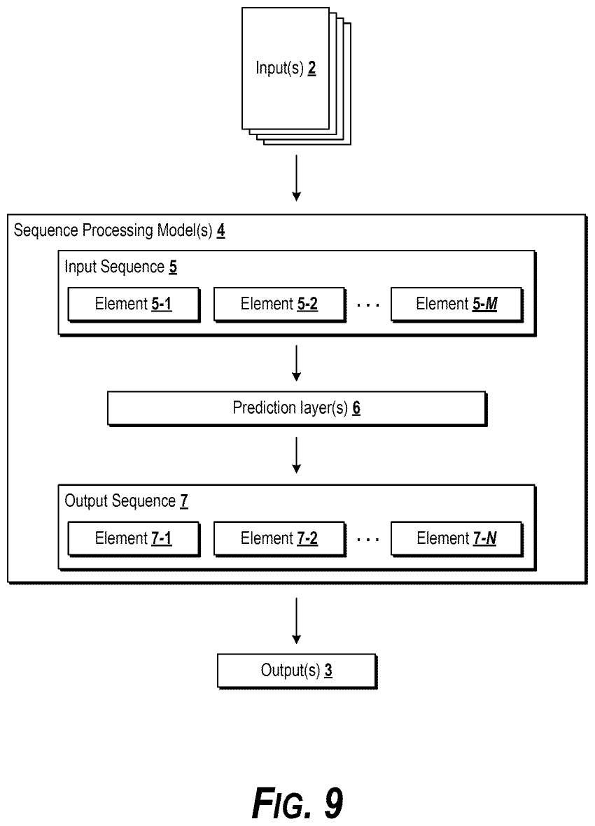

FIG. 9 is a block diagram of an example implementation of an example machine-learned model configured to process sequences of information. For instance, an example implementation of machine-learned model(s) 1 can include machine-learned sequence processing model(s) 4. A machine-learned sequence processing model 4 can in some instances be a reference model 102, proxy model 112, or primary model 132. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV:2010.11929v2 (Jun. 3, 2021), audio domains, see, e.g., Agostinelli et al., MusicLM: Generating Music From Text, ARXIV:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS INNATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 9 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

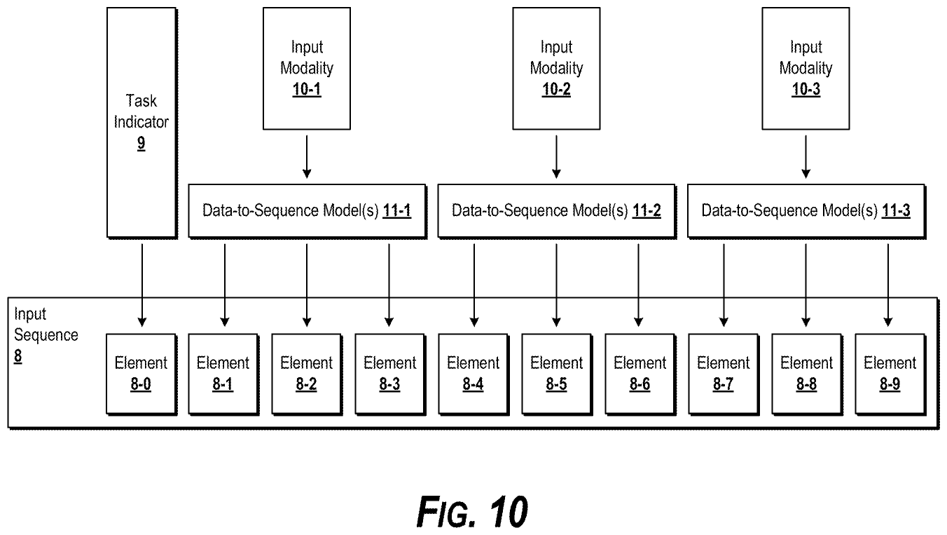

FIG. 10 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be a learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

### Example Machine-Learned Model Development Platform

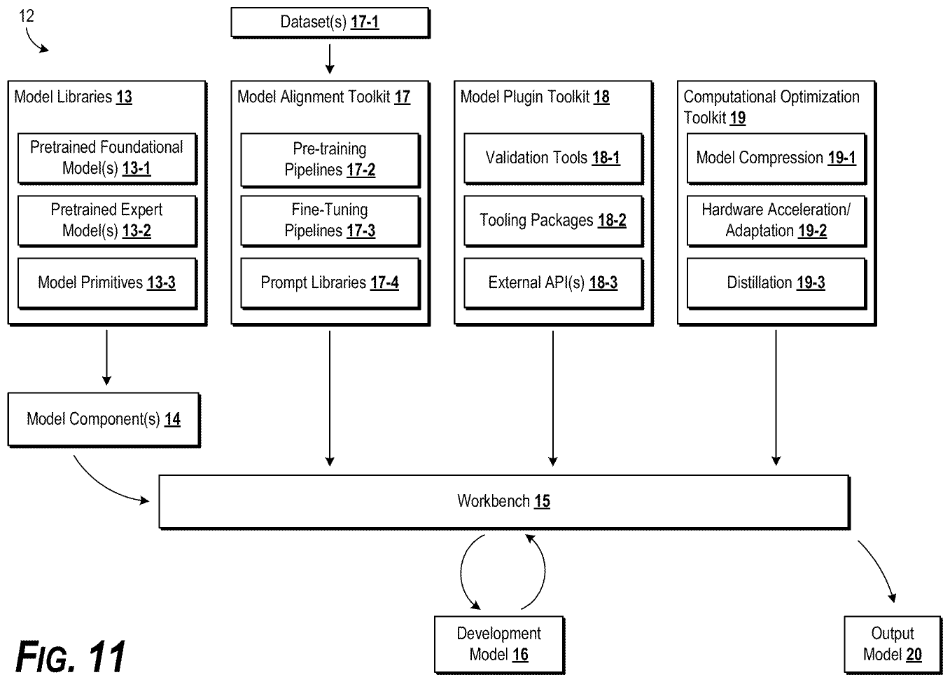

FIG. 11 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired. In some instances, a model library 13 can include a reference model 102.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output a input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 700 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instruction that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16. In some instances, primary model 132 can be a development model 16 or an output model 20.

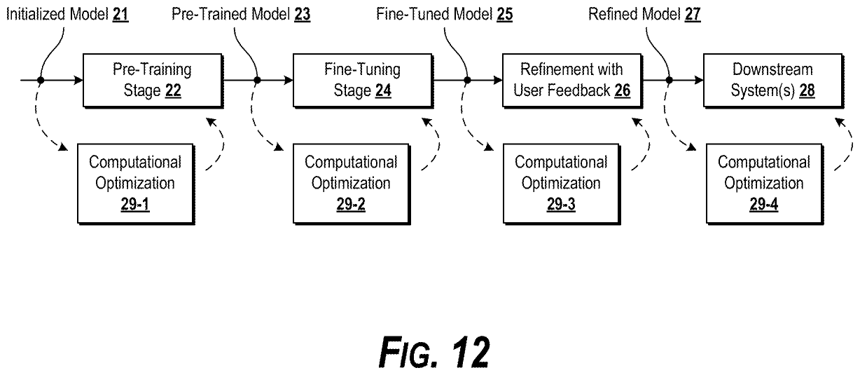

FIG. 12 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 12 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 12 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model. In some instances, an initialized model 21 can be or include a primary model 132 or proxy model 112.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model as satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

### Example Machine-Learned Model Inference System

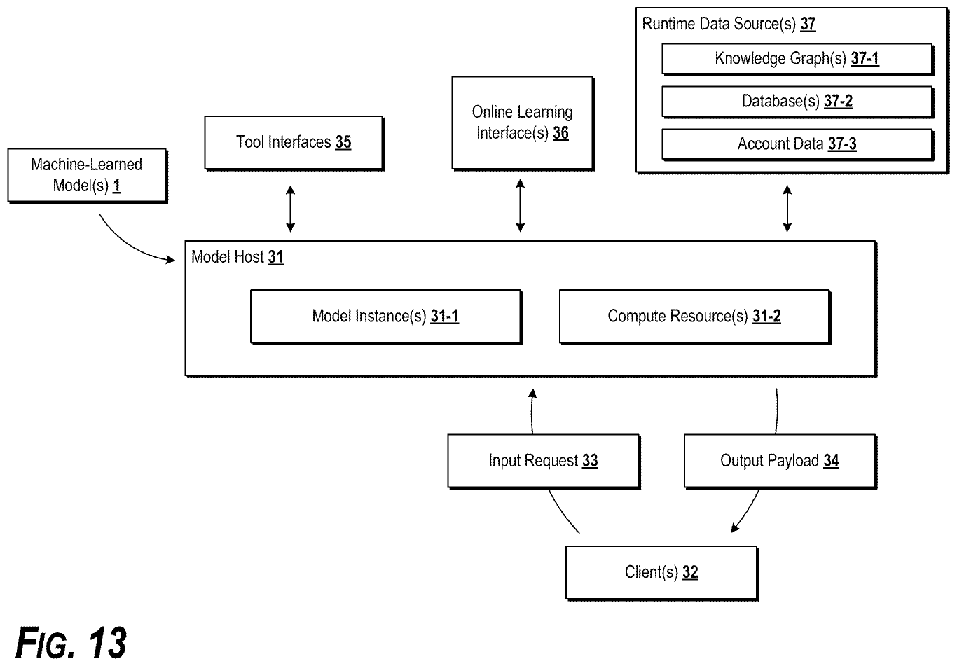

FIG. 13 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored on in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may include compressed audio data. In another example, the input includes visual data (e.g. one or more images or videos), the output includes compressed visual data, and the task is a visual data compression task. In another example, the task may include generating an embedding for input data (e.g. input audio or visual data). In some cases, the input includes audio data representing a spoken utterance and the task is a speech recognition task. The output may include a text output which is mapped to the spoken utterance. In some cases, the task includes encrypting or decrypting input data. In some cases, the task includes a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

### Example Computing Systems and Devices

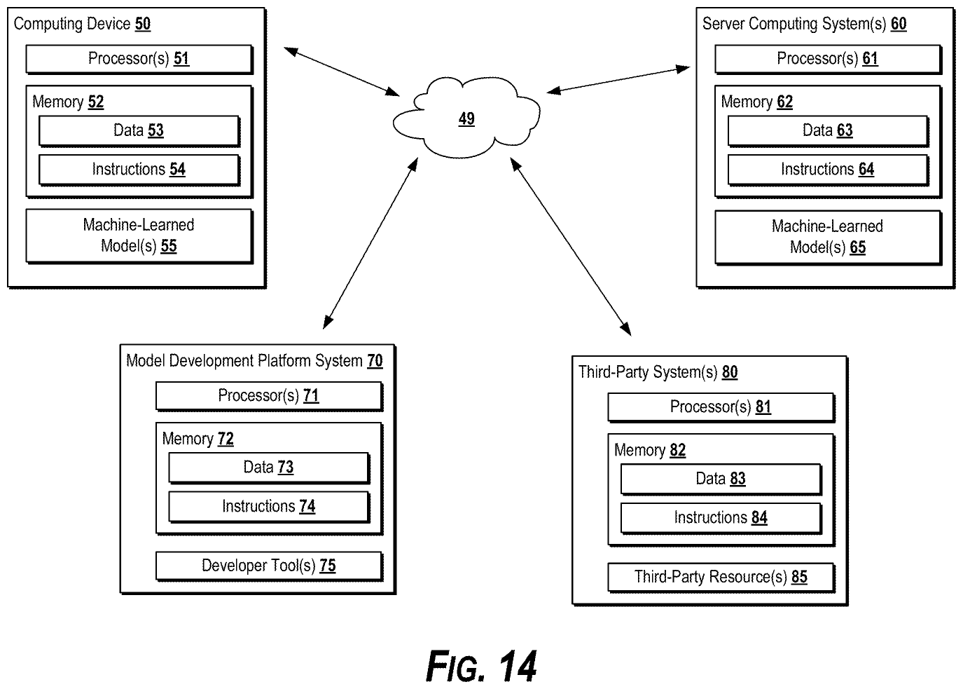

FIG. 14 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 14 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50). In some instances, a computing device 50 can be, comprise, or implement a training system 104, training system 114, or training system 134.

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include a reference model 102, proxy model 112, or primary model 132. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein. In some instances, server computing system(s) 60 can be, comprise, or implement a training system 104, training system 114, or training system 134.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 14 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

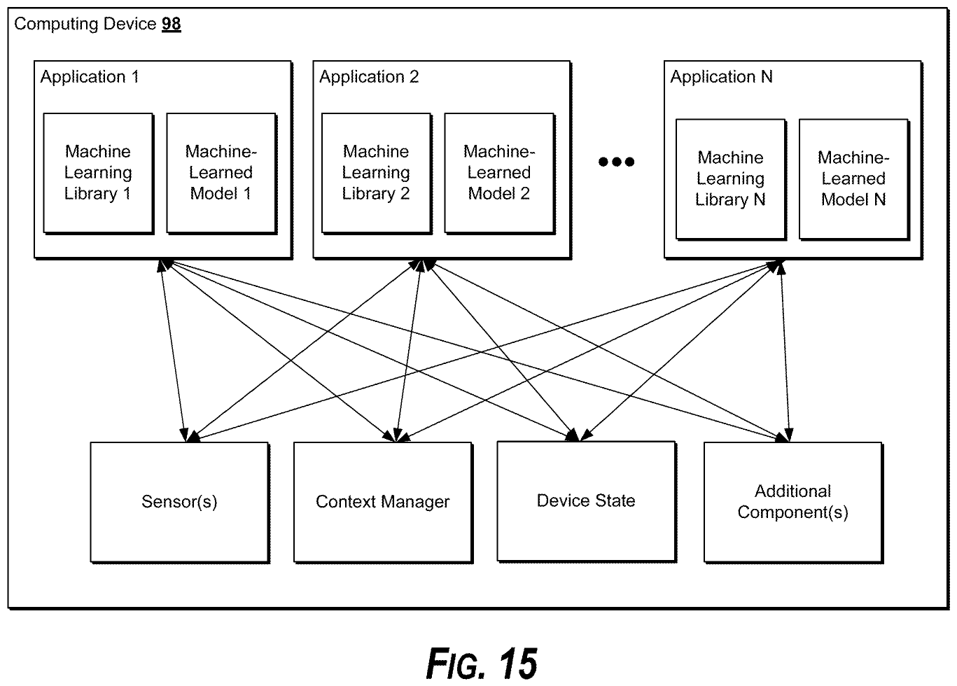

FIG. 15 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 15, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

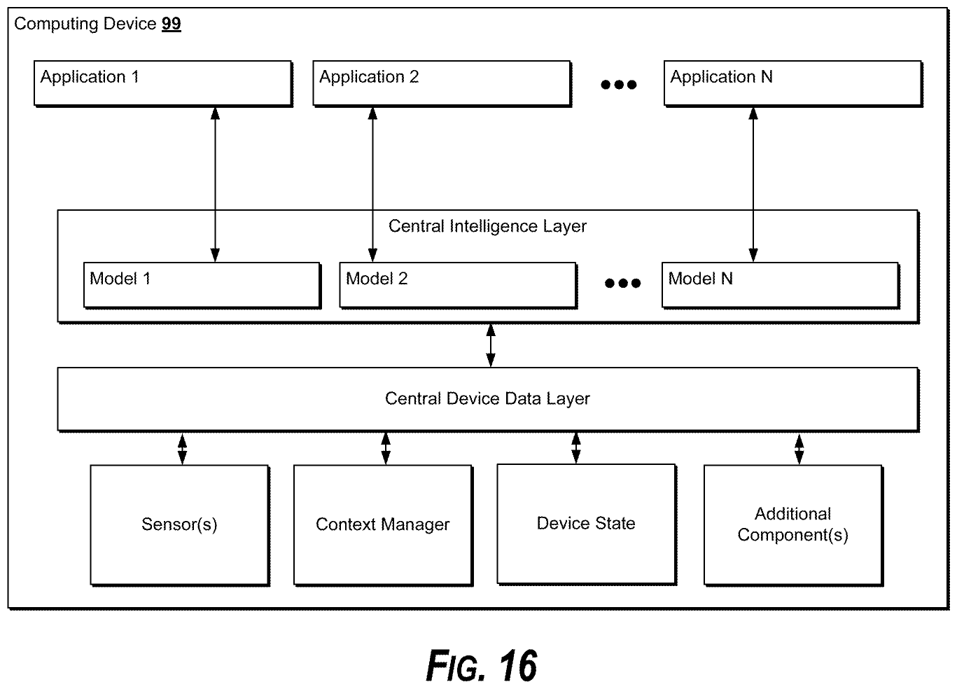

FIG. 16 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 16, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 16, the central device data layer can communicate with a number of other components of the computing device, such as, for example, one or more sensors, a context manager, a device state component, or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method for calibrating a training distribution for training a machine-learned model, the method comprising:
accessing a training dataset characterized by a plurality of data domains;
training a reference model using a first batch of training examples, the first batch of training examples sampled from the training dataset according to an initial probability distribution over the plurality of data domains;
training a proxy model using a second batch of training examples, the second batch of training examples sampled from the training dataset according to a proxy probability distribution over the plurality of data domains, wherein:
the proxy model is trained by evaluating, for a respective training iteration, a comparison between the reference model and the proxy model, wherein the comparison is evaluated using a plurality of learned distribution parameters;
learning, jointly during training of the proxy model, the plurality of learned distribution parameters; and
outputting a calibrated training distribution over the plurality of data domains based on the plurality of learned distribution parameters.

2. The method of claim 1, comprising:
jointly learning the plurality of learned distribution parameters using distributionally robust optimization (DRO) over the plurality of data domains.

3. The method of claim 1, wherein the plurality of learned distribution parameters are used for weighting the comparison between the reference model and the proxy model.

4. The method of claim 1, wherein the plurality of learned distribution parameters are learned based on the comparison between the reference model and the proxy model.

5. The method of claim 4, wherein:
the proxy model is updated to change the comparison in a first direction; and
the plurality of learned distribution parameters are updated to change the comparison in a second, different direction.

6. The method of claim 5, wherein:
jointly learning the learned distribution parameters comprises updating the plurality of learned distribution parameters to amplify a difference metric computed between the reference model and the proxy model, and
training the proxy model comprises updating the proxy model to decrease the difference metric computed between the reference model and the proxy model.

7. The method of claim 6, comprising:
evaluating the comparison by:
determining a plurality of difference metrics respectively for the plurality of data domains, wherein a respective difference metric for a respective domain comprises a comparison between:
values generated by the reference model for training inputs from the respective domain, and
values generated by the proxy model for the training inputs from the respective domain;
weighting the plurality of difference metrics respectively using the plurality of learned distribution parameters; and
aggregating the weighted plurality of difference metrics.

8. The method of claim 7, wherein the respective difference metric comprises an excess loss of the proxy model as compared to the reference model.

9. The method of claim 7, wherein:
the values generated by the proxy model for the training inputs from the respective domain correspond to predictions associated with designated outputs.

10. The method of claim 9, wherein:
a designated output corresponds to a ground truth token.

11. The method of claim 1, comprising:
generating a training trajectory that accumulates a plurality of states for the plurality of learned distribution parameters; and
determining the calibrated training distribution based on the plurality of states.

12. The method of claim 11, comprising:
determining the calibrated training distribution based on the plurality of states by at least one of:
determining an average of the plurality of states;
determining a weighted average of the plurality of states; or
determining a representative value of a cluster of the plurality of states.

13. A computer-implemented method for training a machine-learned model using a calibrated training mixture, the method comprising:
sampling a training example from a training dataset according to a calibrated training distribution; and
training the machine-learned model using the training example;
wherein the calibrated training distribution was calibrated by:
accessing a training dataset characterized by a plurality of data domains;
training a reference model using a first batch of training examples, the first batch of training examples sampled from the training dataset according to an initial probability distribution over the plurality of data domains;
training a proxy model using a second batch of training examples, the second batch of training examples sampled from the training dataset according to a proxy probability distribution over the plurality of data domains, wherein:
the proxy model is trained by evaluating, for a respective training iteration, a comparison between the reference model and the proxy model, wherein the comparison is evaluated using a plurality of learned distribution parameters;
learning, jointly during training of the proxy model, the plurality of learned distribution parameters; and
determining the calibrated training distribution based on the plurality of learned distribution parameters.

14. The method of claim 13, wherein training the machine-learned model is computationally more expensive than training the proxy model.

15. The method of claim 14, wherein:
the machine-learned model is characterized by a first number of parameters;
the proxy model is characterized by a second number of parameters; and
the first number of parameters is at least ten times the second number of parameters.

16. The method of claim 15, wherein:
the first number of parameters is at least thirty times the second number of parameters.

17. The method of claim 13, wherein:
the machine-learned model is trained using a first training task; and
the proxy machine-learned model is trained using a second training task different from the first training task.

18. The method of claim 13, wherein:
a training iteration of the machine-learned model comprises executing a first number of floating point operations; and
a training iteration of the proxy machine-learned model comprises executing a second number of floating point operations that is fewer than the first number of floating point operations.

19. A computing system, comprising:
one or more processors; and
one or more non-transitory computer-readable media storing:
a machine-learned model that was trained using a calibrated training distribution, wherein the calibrated training distribution was calibrated by:
accessing a training dataset characterized by a plurality of data domains;
training a reference model using a first batch of training examples, the first batch of training examples sampled from the training dataset according to an initial probability distribution over the plurality of data domains;
training a proxy model using a second batch of training examples, the second batch of training examples sampled from the training dataset according to a proxy probability distribution over the plurality of data domains, wherein:
the proxy model is trained by evaluating, for a respective training iteration, a comparison between the reference model and the proxy model, wherein the comparison is evaluated using a plurality of learned distribution parameters;
learning, jointly during training of the proxy model, the plurality of learned distribution parameters; and
determining the calibrated training distribution based on the plurality of learned distribution parameters; and
instructions that are executable by the one or more processors to cause the computing system to perform one or more operations, the operations comprising:
obtaining input data; and
generating output data using the machine-learned model and based on the input data.

20. The system of claim 19, wherein the calibrated training distribution was calibrated by:
jointly learning the plurality of learned distribution parameters using distributionally robust optimization (DRO) over the plurality of data domains.
